(19) United States
(12) Patent Application Publication
(10) Pub. No.: US 2021/0344839 A1
(43) Pub. Date: Nov. 4, 2021

(54) IMAGE PROCESSING DEVICE, IMAGE CAPTURING DEVICE, IMAGE PROCESSING METHOD, AND IMAGE PROCESSING PROGRAM

(71) Applicant: FUJIFILM Corporation, Tokyo (JP)

(72) Inventors: Yukinori NISHIYAMA, Saitama-shi (JP); Koichi TANAKA, Saitama-shi (JP); Tetsuya FUJIKAWA, Saitama-shi (JP); Kensuke MASUI, Saitama-shi (JP)

(73) Assignee: FUJIFILM Corporation, Tokyo (JP)

(21) Appl. No.: 17/375,564

(22) Filed: Jul. 14, 2021

Related U.S. Application Data
(63) Continuation of application No. PCT/JP2019/042352, filed on Oct. 29, 2019.

(30) Foreign Application Priority Data
Feb. 6, 2019 (JP) 2019-019957

(51) Int. Cl. H04N 5/232; H04N 5/77

(52) U.S. Cl. CPC H04N 5/23245; H04N 5/77; H04N 5/23229

(57) ABSTRACT

Provided are an image processing device, an image capturing device, and an image processing method. Included are a video acquisition section that acquires a video with a variable image capturing frame rate during image capturing, an image capturing mode selection section that selects a first video capturing mode or a second video capturing mode in which an exposure time per frame is set to be shorter than that in the first video capturing mode, a compression processing selection section that selects first compression processing that prioritizes a capacity in a case where the first video capturing mode is selected or selects second compression processing that prioritizes image quality in a case where the second video capturing mode is selected, and a compression processing section that compresses the video acquired by the video acquisition section and performs the first compression processing or second compression processing selected by the compression processing selection section.

### CROSS-REFERENCE TO RELATED APPLICATIONS

This application is a Continuation of PCT International Application No. PCT/JP2019/042352 filed on Oct. 29, 2019, which claims priority under 35 U.S.0 § 119(a) to Japanese Patent Application No. 2019-019957 filed on Feb. 6, 2019. Each of the above application(s) is hereby expressly incorporated by reference, in its entirety, into the present application.

### BACKGROUND OF THE INVENTION

### Field of the Invention

The present invention relates to an image processing device, an image capturing device, an image processing method, and an image processing program, and more particularly to a video compression technique.

### Description of the Related Art

An amount of data of a video is enormous. Therefore, in a case where the video is recorded, the video is compressed by, for example, a moving picture experts group (MPEG) encoding method for the recording.

In a case where the video is compressed, there is a problem that image quality deteriorates as a compression rate of the video is high while a bit rate (the number of bits transferred or processed per unit time) increases and exceeds processing capability of the device or a storage capacity increases as the compression rate thereof is low.

JP2010-74323A describes that an image capturing section images a video having a frame rate n higher than that of a standard frame rate, converts the video having the high frame rate n into a video having a frame rate n or less, and records the video, and particularly describes that the video is converted and recorded such that the frame rate thereof is higher as the importance of the video is higher.

A recording device described in JP2010-74323A has a description of recording the video by dynamically changing the compression rate according to the importance such that the compression rate of the video having high importance is lowered.

### SUMMARY OF THE INVENTION

JP2010-74323A describes that in a case where the video captured by the image capturing section is recorded, the frame rate is higher as the importance of the video is higher and the compression rate is dynamically changed according to the importance (the compression rate of the video having high importance is lowered). However, the invention described in JP2010-74323A is the recording device having a characteristic in the recording processing for the video captured at the frame rate n higher than the standard frame rate, and does not cover a video having an image capturing frame rate that is variable during the image capturing since the image capturing frame rate of the video is constant (frame rate n higher than the standard frame rate).

JP2010-74323A describes that in a section of low importance, the frame rate is lowered and the compression rate is increased by thinning out frames from a high frame rate n to save a medium capacity. However, there is no description that the compression rate is dynamically changed from a viewpoint of whether to perform the compression processing that prioritizes the capacity or the compression processing that prioritizes image quality.

The present invention has been made in view of such circumstances, and an object thereof is to provide an image processing device, an image capturing device, an image processing method, and an image processing program capable of performing compression processing that satisfies desired image quality and capacity in a case where the compression processing is performed on a video in which an image capturing frame rate is changed during image capturing.

An image processing device according to an aspect of the present invention comprises a video acquisition section that acquires a video with a variable image capturing frame rate during image capturing, an image capturing mode selection section that selects a first video capturing mode or a second video capturing mode in which an exposure time per frame is set to be shorter than that in the first video capturing mode, a compression processing selection section that selects first compression processing in a case where the first video capturing mode is selected or selects second compression processing in a case where the second video capturing mode is selected, and a compression processing section that compresses the video acquired by the video acquisition section and performs the first compression processing or second compression processing selected by the compression processing selection section. In the second compression processing, a change in a capacity per unit time is set to be large and a change in a capacity per frame is set to be small with respect to the change in the image capturing frame rate, as compared with in the first compression processing.

According to one aspect of the present invention, in a case where the compression processing is performed on the video in which the image capturing frame rate is changed during the image capturing, the first compression processing is performed in a case where the first video capturing mode is selected and the second compression processing is performed in a case where the second video capturing mode in which the exposure time per frame is set to be shorter than that in the first video capturing mode is selected. Here, in the second compression processing, the change in the capacity per unit time is set to be large and the change in the capacity per frame is set to be small with respect to the change in the image capturing frame rate, as compared with in the first compression processing. Accordingly, since the video captured in the first video capturing mode has a smaller change in the capacity per unit time with respect to the change in the image capturing frame rate than the video captured in the second video capturing mode, it is possible to suppress the increase and decrease in the capacity (priority is given to the capacity). On the other hand, since the video captured in the second video capturing mode has a smaller change in the capacity per frame with respect to the change in the image capturing frame rate than the video captured in the first video capturing mode, it is possible to suppress a variation in the image quality of the frames constituting the video (priority is given to the image quality).

An image processing device according to another aspect of the present invention comprises a video acquisition section that acquires a video with a variable image capturing frame rate during image capturing, a compression processing selection section that selects first compression processing or second compression processing, a compression processing section that compresses the video acquired by the video acquisition section and performs the first compression processing or second compression processing, selected by the compression processing selection section, and a video file generation section that generates a video file of the video compressed by the compression processing section. In the second compression processing, a change in a capacity per unit time is set to be large and a change in a capacity per frame is set to be small with respect to the change in the image capturing frame rate, as compared with in the first compression processing. The compression processing selection section selects the first compression processing or the second compression processing, according to an environment of a device connected to the video file generation section. The environment is any one of a transfer speed of a recording medium or a communication interface, which is connected to the video file generation section, or a remaining capacity of the recording medium.

According to another aspect of the present invention, in the case where the compression processing is performed on the video in which the image capturing frame rate is changed during the image capturing, a first compression processing or a second compression processing is performed according to the environment of the device connected to the video file generation section. Therefore, it is possible to perform the compression processing (first compression processing that prioritizes the capacity or second compression processing that prioritizes the image quality) suitable for the environment such as the transfer speed of the recording medium or the communication interface, which is connected to the video file generation section, or the remaining capacity of the recording medium with respect to the change in the image capturing frame rate.

The image processing device according to still another aspect of the present invention further comprises a recording section that records the video file generated by the video file generation section on a first recording medium that does not have a transfer speed required for recording a video file of a video compressed by the second compression processing or a second recording medium having the transfer speed. It is preferable that the compression processing selection section selects the first compression processing in a case where the recording section records the video file on the first recording medium or the second compression processing in a case where the recording section records the video file on the second recording medium.

The image processing device according to still another aspect of the present invention further comprises a communication section that transfers the video file generated by the video file generation section to an external device through a first communication interface that does not have a transfer speed required for transferring a video file compressed by the second compression processing or a second communication interface having the transfer speed. It is preferable that the compression processing selection section selects the first compression processing in a case where the communication section transfers the video file through the first communication interface or the second compression processing in a case where the communication section transfers the video file through the second communication interface.

The image processing device according to still another aspect of the present invention further comprises a recording section that records the video file generated by the video file generation section on the recording medium, an image capturing time reception section that receives an image capturing time of a video, and a capacity detection section that detects the remaining capacity of the recording medium. It is preferable that the compression processing selection section selects the first compression processing in a case where the detected remaining capacity of the recording medium is less than a capacity required for recording a video file compressed by the second compression processing or the second compression processing in a case where the detected remaining capacity of the recording medium is equal to or larger than the capacity required for recording the video file compressed by the second compression processing, during the received image capturing time of the video.

The image processing device according to still another aspect of the present invention further comprises a video file generation section that generates a video file of a video compressed by the compression processing section. It is preferable that the video file generation section divides a video compressed by the second compression processing according to the change in the image capturing frame rate to create a plurality of video files and creates a video file of a video compressed by the first compression processing regardless of the change in the image capturing frame rate.

The image processing device according to still another aspect of the present invention further comprises a recording section that records the video file generated by the video file generation section. It is preferable that the recording section records the plurality of video files created from the video compressed by the second compression processing in different storage regions of a recording medium or in different recording media.

In the image processing device according to still another aspect of the present invention, it is preferable that the first compression processing and the second compression processing perform compression processing on the video acquired by the video acquisition section according to a set bit rate set in advance for each image capturing frame rate, in a case where the image capturing frame rate is a first frame rate, the set bit rate of the second compression processing is equal to or higher than the set bit rate of the first compression processing, and in the second compression processing, an amount of change in the set bit rate in a case where the image capturing frame rate changes from the first frame rate to a second frame rate larger than the first frame rate is larger than that in the first compression processing.

In the image processing device according to still another aspect of the present invention, it is preferable that in a case where the first frame rate is α1, the second frame rate is α2, a third frame rate larger than the second frame rate is α3, the set bit rate in the first frame rate is β1, the set bit rate in the second frame rate is β2, and the set bit rate in the third frame rate is β3, the second compression processing satisfies the following expression (1)

(β2−β1)/(α2−α1)>(β3−β2)/(α3−α2) (1).

In the image processing device according to still another aspect of the present invention, it is preferable that the compression processing section determines a quantization parameter of image data of frames constituting the video acquired by the video acquisition section to be equal to or less than an upper limit value and compresses the image data using the determined quantization parameter, and a difference between the second frame rate of the second compression processing and the upper limit value of the first frame rate is smaller than a difference between the second frame rate of the first compression processing and the upper limit value of the first frame rate.

In the image processing device according to still another aspect of the present invention, it is preferable that in the second video capturing mode, at least one of a speed of autofocus, a tracking speed of automatic exposure, a tracking speed of white balance, or a frame rate is set to be faster than that in the first video capturing mode.

An image capturing device according to still another aspect of the present invention further comprises a video capturing section that captures a video with a variable image capturing frame rate and the image processing device described above. The video acquisition section acquires the video captured by the video capturing section.

An image processing method according to still another aspect of the present invention further comprises a step of acquiring a video with a variable image capturing frame rate during image capturing, a step of selecting first compression processing or second compression processing, a step of compressing the acquired video and performing the selected first compression processing or second compression processing, and a step of selecting a first video capturing mode or a second video capturing mode in which an exposure time per frame is set to be shorter than that in the first video capturing mode. In the second compression processing, the change in the capacity per unit time is set to be large and the change in the capacity per frame is set to be small with respect to the change in the image capturing frame rate, as compared with in the first compression processing. In the step of selecting the first compression processing or the second compression processing, the first compression processing is selected in a case where the first video capturing mode is selected and the second compression processing is selected in a case where the second video capturing mode is selected.

An image processing method according to still another aspect of the present invention further comprises a step of acquiring a video with a variable image capturing frame rate during image capturing, a step of selecting first compression processing or second compression processing, a step of compressing the acquired video and performing the selected first compression processing or second compression processing, and a step of generating a video file of the compressed video, by a video file generation section. In the second compression processing, the change in the capacity per unit time is set to be large and the change in the capacity per frame is set to be small with respect to the change in the image capturing frame rate, as compared with in the first compression processing. In the step of selecting the first compression processing or the second compression processing, the first compression processing or the second compression processing is selected according to an environment of a device connected to the video file generation section. The environment is any one of a transfer speed of a recording medium or a communication interface, which is connected to the video file generation section, or a remaining capacity of the recording medium.

In the image processing method according to still another aspect of the present invention, it is preferable that the first compression processing and the second compression processing perform compression processing on the acquired video according to a set bit rate set in advance for each image capturing frame rate, in a case where the image capturing frame rate is a first frame rate, the set bit rate of the second compression processing is equal to or higher than the set bit rate of the first compression processing, and in the second compression processing, an amount of change in the set bit rate in a case where the image capturing frame rate changes from the first frame rate to a second frame rate larger than the first frame rate is larger than that in the first compression processing.

An image processing program according to an aspect of the present invention causes a computer to realize a function of acquiring a video with a variable image capturing frame rate during image capturing, a function of selecting first compression processing or second compression processing, a function of compressing the acquired video and performing the selected first compression processing or second compression processing, and a function of selecting a first video capturing mode or a second video capturing mode in which an exposure time per frame is set to be shorter than that in the first video capturing mode. In the second compression processing, the change in the capacity per unit time is set to be large and the change in the capacity per frame is set to be small with respect to the change in the image capturing frame rate, as compared with in the first compression processing. In the function of selecting the first compression processing or the second compression processing, the first compression processing is selected in a case where the first video capturing mode is selected and the second compression processing is selected in a case where the second video capturing mode is selected.

According to the present invention, it is possible to perform the compression processing that satisfies the desired image quality and the capacity in the case where the compression processing is performed on the video in which the image capturing frame rate is changed during the image capturing.

### BRIEF DESCRIPTION OF THE DRAWINGS

FIG. 1 is a perspective view of an image capturing device according to the present invention as viewed obliquely from the front.

FIG. 2 is a rear view of the image capturing device.

FIG. 3 is a block diagram showing an embodiment of an internal configuration of the image capturing device.

FIG. 4 is a block diagram showing a first embodiment of an image processing device according to the present invention.

FIG. 5 is a graph showing a first example of a set bit rate set based on first compression processing or second compression processing and an image capturing frame rate.

FIG. 6 is a schematic diagram showing a relationship between a change in a generated code amount (bit rate) after quantization of image data of a past frame and a QP value in a case where compression processing is performed on a video.

FIG. 7 is a graph showing a second example of the set bit rate set based on the first compression processing or the second compression processing and the image capturing frame rate.

FIG. 8 is a graph showing a third example of the set bit rate set based on the first compression processing or the second compression processing and the image capturing frame rate.

FIG. 9 is a table showing a range of the set bit rate set based on the first compression processing or the second compression processing and the image capturing frame rate and the QP value.

FIG. 10 is a block diagram showing a second embodiment of an image processing device according to the present invention.

FIG. 11 is a block diagram showing a third embodiment of an image processing device according to the present invention.

FIG. 12 is a flowchart showing an embodiment of an image processing method according to the present invention.

FIG. 13 is a flowchart showing details of the compression processing of the video in step S30 of FIG. 12.

FIG. 14 is an external view of a smartphone which is another embodiment of the image capturing device according to the present invention.

FIG. 15 is a block diagram showing a configuration of the smartphone.

### DESCRIPTION OF THE PREFERRED EMBODIMENTS

Hereinafter, preferred embodiments of an image processing device, an image capturing device, an image processing method, and an image processing program according to the present invention will be described with reference to accompanying drawings.

### Appearance of Image Capturing Device

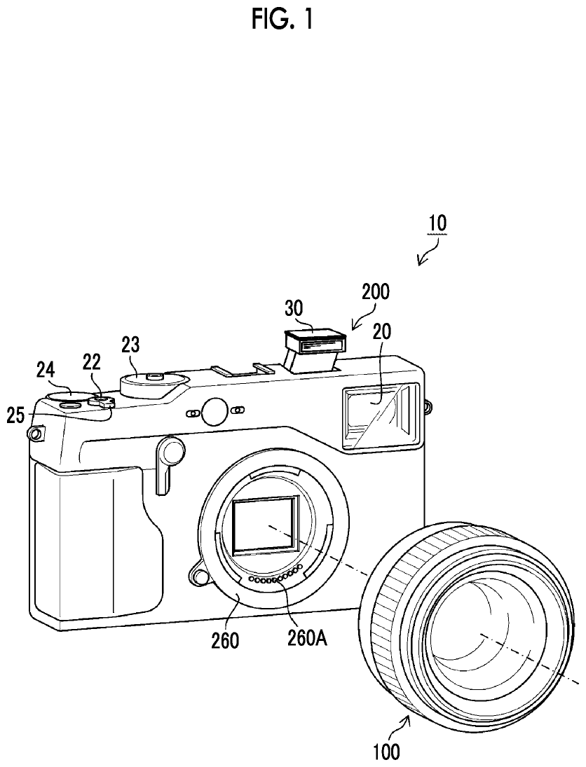

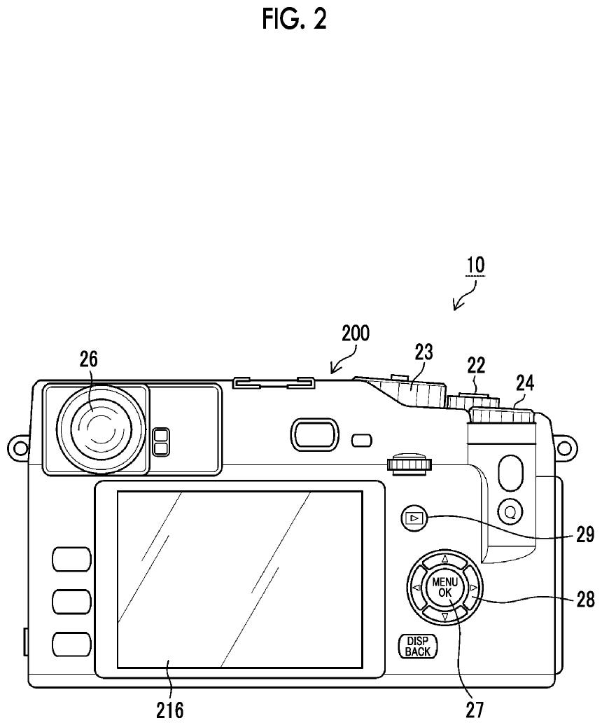

FIG. 1 is a perspective view of an image capturing device according to the present invention as viewed obliquely from the front, and FIG. 2 is a rear view of the image capturing device.

As shown in FIG. 1, an image capturing device 10 is a mirrorless digital single-lens camera composed of an interchangeable lens 100 and a camera body 200 to and from which the interchangeable lens 100 is attached and detached.

In FIG. 1, a body mount 260 to which the interchangeable lens 100 is attached, a view finder window 20 of an optical viewfinder, and the like are provided on a front surface of the camera body 200. A shutter release switch 22, a shutter speed dial 23, an exposure correction dial 24, a power lever 25, and a built-in flash 30 are mainly provided on an upper surface of the camera body 200.

As shown in FIG. 2, a liquid crystal monitor 216, an eyepiece section 26 of the optical viewfinder, a MENU/OK key 27, a cross key 28, a playback button 29, and the like are mainly provided on a back surface of the camera body 200.

The liquid crystal monitor 216 displays a live view image in an image capturing mode or performs a playback display of a captured image in a playback mode, and functions as a display section that displays various menu screens and as a notification section that notifies a user of various pieces of information. The MENU/OK key 27 is an operation key having both a function as a menu button for performing a command to display a menu on the screen of the liquid crystal monitor 216 and a function as an OK button for performing a command to confirm, execute, and the like of a selected content. The cross key 28 is an operation section that inputs instructions in four directions of up, down, left, and right, and functions as a multi-function key for selecting an item from the menu screen or for performing an instruction to select various setting items from each menu. Up and down keys of the cross key 28 function as zoom switches during the image capturing or playback zoom switches during the playback mode. Left and right keys thereof function as frame feed (forward and reverse directions) buttons during the playback mode. The cross key 28 also functions as an operation section that designates a random subject whose focus is adjusted from among a plurality of subjects displayed on the liquid crystal monitor 216.

The MENU/OK key 27, the cross key 28, and the liquid crystal monitor 216 function as an image capturing mode selection section that selects various image capturing modes, as an image capturing frame rate instruction section that issues an instruction to set and change the image capturing frame rate of the video, and as an image capturing time reception section that receives an image capturing time of the video.

That is, it is possible to set a static image capturing mode for capturing a static image and a video capturing mode for capturing the video by operating the MENU/OK key 27, displaying the menu screen on the liquid crystal monitor 216, and using the menu screen. The video capturing mode includes a first video capturing mode and a second video capturing mode having a different image capturing condition from the first video capturing mode.

In the second video capturing mode, an exposure time per frame is set to be shorter than at least in the first video capturing mode.

In this example, the first video capturing mode is a video capturing mode for a normal video in which an image capturing condition suitable for viewing the video itself is set. The second video capturing mode is a video capturing mode for the static image extraction in which an image capturing condition that emphasizes the static image extraction rather than viewing the video itself is set.

Specifically, in the second video capturing mode, a shutter speed and at least one of a speed of autofocus (speed of driving a focus lens to move toward a target focusing distance), a tracking speed of automatic exposure, or a tracking speed of white balance are set to be faster than that in the first video capturing mode and/or the frame rate is set higher than that in the first video capturing mode. Resolution is set to the highest values (for example, 4,000×2,000 pixels) that can be set by the image capturing device 10, and a tone is also set on an assumption of the static image extraction. An upper limit of ISO sensitivity is also set to be higher than that in the first video capturing mode.

For example, the shutter speed is set to a value corresponding to the frame rate of the video to be recorded in the first video capturing mode (1/30 seconds in a case where the frame rate is 30 fps), but is set to be faster (for example, less than 1/30 seconds) than a frame interval in the second video mode. In the first video capturing mode, the shutter speed is set to a value corresponding to the frame rate of the video such that a smooth video is played back. However, a moving subject may be blurred in this case. Therefore, in the second video capturing mode, the shutter speed is set to be higher than that in the first video capturing mode (higher than the frame interval). Accordingly, it is possible to extract a high-quality static image with less blurring of the subject. Similarly, it is possible to increase the shutter speed by increasing the upper limit of ISO sensitivity, and thus it is possible to extract a static image with less blurring. The speed of autofocus, the tracking speed of automatic exposure, the tracking speed of auto white balance, or the like is set to be faster than that in the first video capturing mode. Therefore, it is possible to acquire many frames focused on the subject, many frames with appropriate exposure, and the like.

With the second video capturing mode described above, it is possible to store the video and extract the frame constituting the video as the static image. Therefore, the user can easily image a photograph of an event (natural phenomenon, accident, happening, or the like) unpredictable when the event occurs, a photograph of a momentary state of the subject whose state changes with the passage of time or a moving subject, and the like. With the setting of the image capturing conditions (shutter speed, resolution, and the like) suitable for the static image extraction, it is possible to extract a high-quality static image.

The playback button 29 is for switching to the playback mode in which the recorded static image or video is displayed on the liquid crystal monitor 216.

### Internal Configuration of Image Capturing Device

### Interchangeable Lens

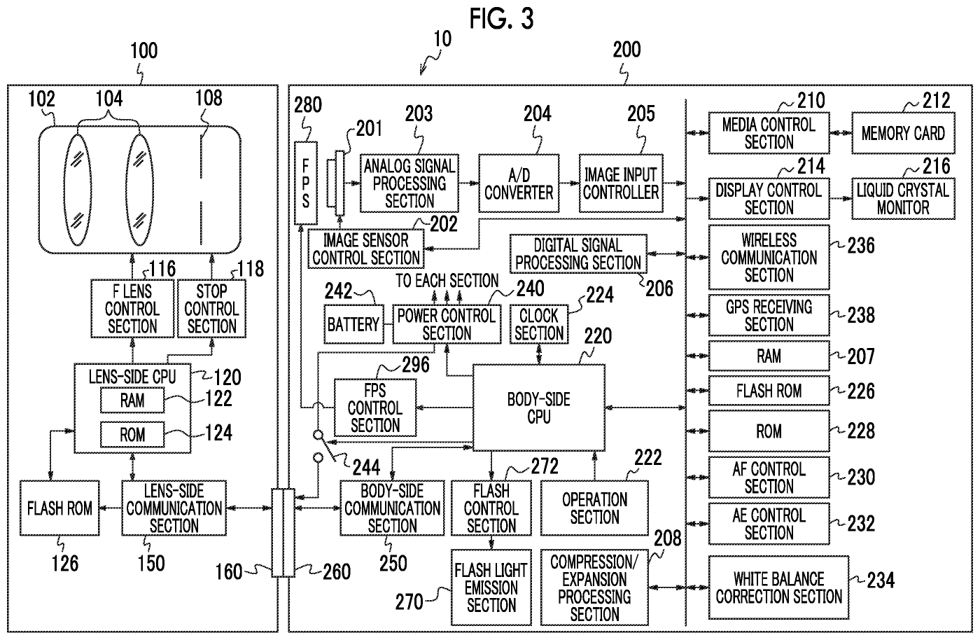

FIG. 3 is a block diagram showing an embodiment of an internal configuration of the image capturing device 10.

The interchangeable lens 100 that functions as an image capturing optical system constituting the image capturing device 10 is manufactured according to a communication standard of the camera body 200 and is an interchangeable lens capable of communicating with the camera body 200 as described below. The interchangeable lens 100 comprises an image capturing optical system 102, a focus lens control section 116, a stop control section 118, a lens-side central processing unit (CPU) 120, a flash read only memory (ROM) 126, a lens-side communication section 150, and a lens mount 160.

The image capturing optical system 102 of the interchangeable lens 100 includes a lens group 104 including the focus lens and a stop 108.

The focus lens control section 116 moves the focus lens according to a command from the lens-side CPU 120 to control a position of the focus lens (focusing position). The stop control section 118 controls the stop 108 according to the command from the lens-side CPU 120.

The lens-side CPU 120 integrally controls the interchangeable lens 100, and a ROM 124 and a random access memory (RAM) 122 are built in the lens-side CPU 120.

The flash ROM 126 is a non-volatile memory that stores a program and the like downloaded from the camera body 200.

The lens-side CPU 120 integrally controls each section of the interchangeable lens 100 according to a control program stored in the ROM 124 or the flash ROM 126, using the RAM 122 as a work region.

The lens-side communication section 150 communicates with the camera body 200 through a plurality of signal terminals (lens-side signal terminals) provided on the lens mount 160 in a state where the lens mount 160 is attached to the body mount 260 of the camera body 200. That is, the lens-side communication section 150 transmits and receives (bidirectional communication) a request signal and a reply signal to and from a body-side communication section 250 of the camera body 200 connected through the lens mount 160 and the body mount 260 according to the command from the lens-side CPU 120 to notify the camera body 200 of lens information (position information of the focus lens, focal length information, stop information, and the like) of each optical member of the image capturing optical system 102.

The interchangeable lens 100 also comprises a detection section (not shown) that detects the position information of the focus lens and the stop information. The stop information indicates an F number of the stop 108, an opening diameter of the stop 108, and the like.

The lens-side CPU 120 preferably holds various pieces of lens information including the detected focus lens position information and stop information in the RAM 122 in order to respond to a request for lens information from the camera body 200. The lens information is detected in a case where there is the request for lens information from the camera body 200, in a case where the optical member is driven, or at a constant cycle (a cycle sufficiently shorter than a frame cycle of the video). The lens information can hold the detection result.

### Camera Body

The camera body 200 constituting the image capturing device 10 shown in FIG. 3 comprises an image sensor 201, an image sensor control section 202, an analog signal processing section 203, an analog/digital (A/D) converter 204, an image input controller 205, a digital signal processing section 206, a RAM 207, a compression/expansion processing section 208, a media control section 210, a memory card 212, a display control section 214, a liquid crystal monitor 216, a body-side CPU 220, an operation section 222, a clock section 224, a flash ROM 226, a ROM 228, an autofocus (AF) control section 230, an auto exposure (AE) control section 232, a white balance correction section 234, a wireless communication section 236, a global positioning system (GPS) receiving section 238, a power control section 240, a battery 242, a body-side communication section 250, a body mount 260, a flash light emission section 270 constituting the built-in flash 30 (FIG. 1), a flash control section 272, a focal-plane shutter (FPS) 280, and an FPS control section 296.

The image sensor 201 is composed of a complementary metal-oxide semiconductor (CMOS) type color image sensor. The image sensor 201 is not limited to the CMOS type, but may be an XY address type or a charge-coupled device (CCD) type image sensor.

In each pixel of the image sensor 201, any one color filter of color filters (R filter, G filter, B filter) of three primary colors of red (R), green (G), and blue (B) is disposed according to a predetermined color filter array. The color filter array may be a general Bayer array, but is not limited thereto and may be another color filter array such as a Trans (registered trademark) array.

The image sensor 201 converts an optical image of the subject formed on a light receiving surface of the image sensor 201 by the image capturing optical system 102 of the interchangeable lens 100 into an electric signal. An electric charge corresponding to an amount of incident light is accumulated in each pixel of the image sensor 201, and an electric signal corresponding to an amount of electric charge (signal charge) accumulated in each pixel is read out as an image signal from the image sensor 201.

The image sensor control section 202 controls the readout of the image signal from the image sensor 201 according to a command from the body-side CPU 220. In a case where the static image is captured, the image sensor control section 202 controls an exposure time by opening and closing the FPS 280 and then reads out all lines of the image sensor 201 in a state where the FPS 280 is closed. The image sensor 201 and the image sensor control section 202 of the present example can be driven by a so-called rolling shutter method in which an exposure operation is sequentially performed for at least one or more lines or pixels (that is, a method of sequentially resetting each line or pixel, starting electric charge accumulation, and reading out the accumulated electric charge), and in particular, have a function of capturing the video or the live view image by the rolling shutter method in a state where the FPS 280 is opened.

The analog signal processing section 203 performs various kinds of analog signal processing on an analog image signal obtained by capturing the subject with the image sensor 201. The analog signal processing section 203 is composed of including a sampling hold circuit, a color separation circuit, an automatic gain control (AGC) circuit, and the like. The AGC circuit functions as a sensitivity adjustment section that adjusts the sensitivity (ISO sensitivity (international organization for standardization: ISO)) at the time of image capturing and adjusts a gain of an amplifier that amplifies an input image signal such that a signal level of the image signal is in an appropriate range. The A/D converter 204 converts the analog image signal output from the analog signal processing section 203 into a digital image signal.

Image data (mosaic image data) for each pixel of RGB output through the image sensor 201, the analog signal processing section 203, and the A/D converter 204 at the time of capturing the static image or the video is input from the image input controller 205 to the RAM 207 and is temporarily stored. In a case where the image sensor 201 is the CMOS type image sensor, the analog signal processing section 203 and the A/D converter 204 are often built in the image sensor 201.

The digital signal processing section 206 performs various types of digital signal processing on the image data stored in the RAM 207. The digital signal processing section 206 reads out the image data stored in the RAM 207 as appropriate, performs digital signal processing such as offset processing, gain control processing including sensitivity correction, gamma correction processing, demosaicing, and RGB/YCrCb conversion processing on the readout image data, and stores the image data after the digital signal processing in the RAM 207 again. The demosaicing is processing of, for example, calculating color information of all the RGB for each pixel from a mosaic image consisting of RGB in a case of the image sensor consisting of the color filters of RGB three colors, and generates demosaiced image data of RGB three planes from mosaic data (dot-sequential RGB data).

The RGB/YCrCb conversion processing is processing of converting the demosaiced RGB data into brightness data (Y) and color difference data (Cb and Cr).

The compression/expansion processing section 208 functions as a compression processing section that performs compression processing on uncompressed brightness data Y and color difference data Cb and Cr once stored in the RAM 207 at the time of recording the static image or the video. In a case of the static image, the static image is compressed in a joint photographic coding experts group (JPEG) format, for example. In a case of the video, the video is compressed by an H.264/advanced video coding (AVC) method, which is one of MPEG encoding methods, for example. The image data compressed by the compression/expansion processing section 208 is recorded in the memory card 212 through the media control section 210. The compression/expansion processing section 208 performs expansion processing on the compressed image data obtained from the memory card 212 through the media control section 210 in the playback mode to function as a compression/expansion section that generates uncompressed image data.

Details of the compression/expansion processing section 208 (particularly, compression processing section) according to the present invention will be described below.

The media control section 210 functions as a static image file generation section and a video file generation section that generate a static image file and a video file from the image data compressed by the compression/decompression processing section 208, and also functions as a recording section that records the generated static image file or video file in the memory card 212. The media control section 210 controls to read out the static image file or the video file from the memory card 212. In a case where an internal memory is set as a recording destination, the media control section 210 can record the static image file or the video file in the internal memory (for example, flash ROM 226) of the camera body 200.

The display control section 214 controls displaying of the uncompressed image data stored in the RAM 207 on the liquid crystal monitor 216. The liquid crystal monitor 216 is composed of a liquid crystal display device, but may be composed of a display device such as organic electroluminescence instead of the liquid crystal monitor 216.

In a case where the live view image is displayed on the liquid crystal monitor 216, the digital image signals continuously generated by the digital signal processing section 206 are temporarily stored in the RAM 207. The display control section 214 converts the digital image signals temporarily stored in the RAM 207 into a signal format for display and sequentially outputs the converted signals to the liquid crystal monitor 216. Accordingly, the captured image is displayed on the liquid crystal monitor 216 in real time, and thus the liquid crystal monitor 216 can be used as an electronic viewfinder.

The shutter release switch 22 is an image capturing instruction section to which an instruction to capture the static image or the video is input and is composed of a two-stage stroke type switch consisting of so-called “half-way pressing” and “full-way pressing”.

In a case of the static image capturing mode, an S1 ON signal is output by pressing the shutter release switch 22 halfway, and an S2 ON signal is output by pressing the shutter release switch 22 fully, by further pressing the switch from the half-way pressing. The body-side CPU 220 executes image capturing preparation processing such as AF control (automatic focus adjustment) and AE control (automatic exposure control) in a case where the S1 ON signal is output, and executes image capturing processing and recording processing of the static image in a case where the S2 ON signal is output.

It is needless to say that the AF and the AE are automatically performed in a case where the AF and the AE are set in an auto mode the operation section 222, and are not performed in a case where the AF and the AE are set in a manual mode.

In a case of the video capturing mode (the first video capturing mode for the normal video or the second video capturing mode for the static image extraction), in the case where the S2 ON signal is output by pressing the shutter release switch 22 fully, the camera body 200 enters a video recording mode in which the recording of the video is started to execute the image processing and the recording processing of the video. Thereafter, in a case where the S2 ON signal is output by pressing the shutter release switch 22 fully again, the camera body 200 enters a standby state to temporarily stop the recording processing of the video.

The shutter release switch 22 is not limited to the two-stage stroke type switch consisting of the half-way pressing and the full-way pressing. The S1 ON signal and the S2 ON signal may be output by one operation or by a separate switch provided for each.

In a form in which an operation instruction is issued using a touch panel or the like, the operation instruction may be output by touching a region corresponding to the operation instruction displayed on a screen of the touch panel as an operation unit thereof. As long as an instruction to perform the image capturing preparation processing or the image capturing processing is issued, the form of the operation unit is not limited to these.

The static image or video acquired by the image capturing is compressed by the compression/expansion processing section 208. The compressed image data is converted into an image file in which necessary additional information of image capturing date/time, GPS information, image capturing conditions (F number, shutter speed, ISO sensitivity, and the like) is added to a header and then stored in the memory card 212 by the media control section 210.

The body-side CPU 220 integrally controls the entire operation of the camera body 200, the driving of the optical member of the interchangeable lens 100, and the like. The body-side CPU 220 controls each section of the camera body 200 and the interchangeable lens 100 based on the inputs from the operation section 222 including the shutter release switch 22 and the like.

The clock section 224 measures a time based on the command from the body-side CPU 220 as a timer. The clock section 224 measures a current date and time as a calendar.

The flash ROM 226 is a readable and writable non-volatile memory and stores setting information.

The ROM 228 stores a camera control program executed by the body-side CPU 220, an image processing program according to the present invention, defect information of the image sensor 201, and various parameters or tables used for image processing and the like. The body-side CPU 220 controls each section of the camera body 200 and the interchangeable lens 100 according to the camera control program or the image processing program stored in the ROM 228 while using the RAM 207 as a work region.

In a case where the image sensor 201 includes a phase difference pixel, the AF control section 230 functioning as an automatic focus adjustment section calculates a defocus amount necessary for controlling a phase difference AF and notifies the interchangeable lens 100, through the body-side CPU 220 and the body-side communication section 250, of a command of position (focusing position) where the focus lens is required to be moved based on the calculated defocus amount.

The position command of the focus lens corresponding to the defocus amount calculated by the AF control section 230 is notified to the interchangeable lens 100. The lens-side CPU 120 of the interchangeable lens 100, which receives the position command of the focus lens, moves the focus lens through the focus lens control section 116 to control the position (focusing position) of the focus lens. The AF control section 230 is not limited to the controlling of the phase difference AF and may control contrast AF in which the focus lens is moved such that contrast of an AF region is maximized

The AE control section 232 is a part that detects brightness of the subject (subject brightness) and calculates a numerical value (exposure value (EV value)) necessary for the AE control and auto white balance (AWB) control corresponding to the subject brightness. The AE control section 232 calculates the EV value based on the brightness of the image acquired through the image sensor 201 and the shutter speed and F number at the time of acquiring the brightness of the image.

The body-side CPU 220 can determine the F number, the shutter speed, and the ISO sensitivity from a predetermined program diagram based on the EV value obtained from the AE control section 232, and thus can perform the AE control.

The white balance correction section 234 calculates white balance gains (WB gains) of Gr, Gg, and Gb for each color data of the RGB data (R data, G data, and B data) and multiplies the R data, the G data, and the B data by the calculated WB gains of Gr, Gg, and Gb, respectively, to perform the white balance correction. As a method of calculating the WB gains of Gr, Gg, and Gb, a method is conceivable in which a light source type that illuminates the subject is specified based on scene recognition (outdoor/indoor determination or the like) by the brightness (EV value) of the subject, color temperature of ambient light, and the like and a WB gain corresponding to the specified light source type is read out from the storage section that stores an appropriate WB gain in advance for each light source type. Another known method is conceivable in which at least the EV value is used to obtain the WB gains of Gr, Gg, and Gb.

The wireless communication section 236 is a part that performs short-distance wireless communication of standards such as wireless fidelity (Wi-Fi) (registered trademark) and Bluetooth (registered trademark), and transmits and receives necessary information to and from a peripheral digital device (portable terminal such as smartphone).

The GPS receiving section 238 receives GPS signals transmitted from a plurality of GPS satellites in response to the instruction from the body-side CPU 220 and executes positioning calculation processing based on the plurality of received GPS signals to acquire GPS information consisting of latitude, longitude, and altitude of the camera body 200. The acquired GPS information can be recorded in the header of the image file as additional information indicating an image capturing position of the captured image.

The power control section 240 provides a power voltage supplied from the battery 242 to each section of the camera body 200 according to the command from the body-side CPU 220. The power control section 240 provides the power voltage supplied from the battery 242 to each section of the interchangeable lens 100 through the body mount 260 and the lens mount 160 according to the command from the body-side CPU 220.

The lens power switch 244 switches on and off the power voltage provided to the interchangeable lens 100 through the body mount 260 and the lens mount 160 and switches a level according to the command from the body-side CPU 220.

The body-side communication section 250 transmits and receives (bidirectional communication) a request signal and a reply signal to and from the lens-side communication section 150 of the interchangeable lens 100 connected through the body mount 260 and the lens mount 160 according to the command from the body-side CPU 220. The body mount 260 is provided with a plurality of terminals 260A as shown in FIG. 1. In a case where the interchangeable lens 100 is attached to the camera body 200 (the lens mount 160 and the body mount 260 are connected), the plurality of terminals 260A (FIG. 1) provided on the body mount 260 and a plurality of terminals (not shown) provided on the lens mount 160 are electrically connected to each other. Therefore, the bidirectional communication is possible between the body-side communication section 250 and the lens-side communication section 150.

The built-in flash 30 (FIG. 1) is, for example, a flash of a through the lens (TTL) automatic dimming system and is composed of the flash light emission section 270 and the flash control section 272.

The flash control section 272 has a function of adjusting an amount of light emission (guide number) of flash light emitted from the flash light emission section 270. In other words, the flash control section 272 preliminary emits (dimming emission) flash light having a small amount of light emission from the flash light emission section 270 in synchronization with a flash image capturing instruction from the body-side CPU 220, determines an amount of light emission of the flash light to be mainly emitted based on reflected light (including ambient light) incident through the image capturing optical system 102 of the interchangeable lens 100, and emits (main emission) the flash light having the determined amount of light emission from the flash light emission section 270.

The FPS 280 constitutes a mechanical shutter of the image capturing device 10 and is disposed immediately in front of the image sensor 201. The FPS control section 296 controls the opening and closing of front and rear curtains of the FPS 280 based on the input information (S2 ON signal, shutter speed, and the like) from the body-side CPU 220 to control the exposure time (shutter speed) in the image sensor 201.

Next, the compression/expansion processing section 208 in which the first video capturing mode or the second video capturing mode is set and a video captured in the first video capturing mode or the second video capturing mode is compressed will be described.

### First Embodiment

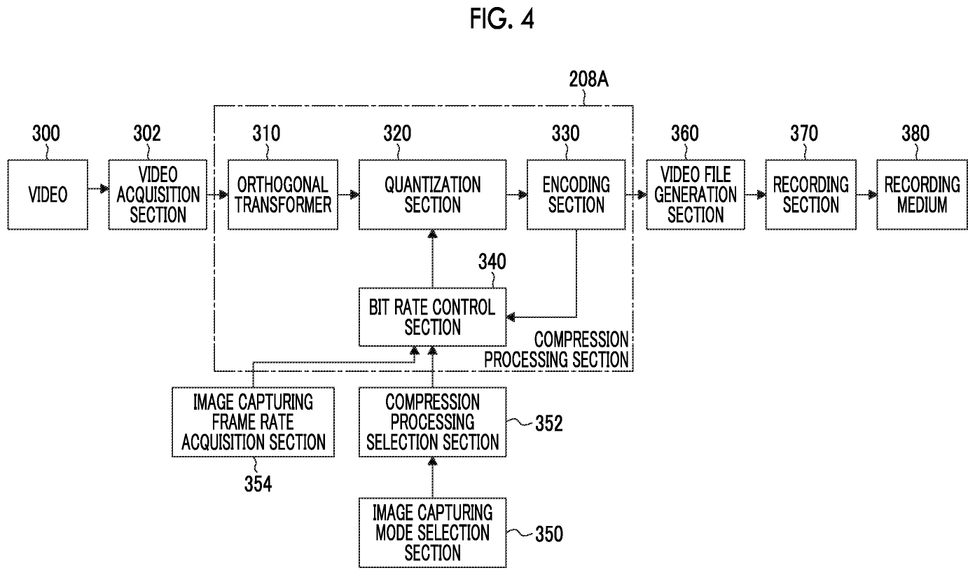

FIG. 4 is a block diagram showing a first embodiment of an image processing device according to the present invention.

The image processing device shown in FIG. 4 is a part corresponding to the compression/decompression processing section 208 of the camera body 200, the main body-side CPU 220, the operation section 222, and the like, and is mainly composed of a video acquisition section 302, a compression processing section 208A, an image capturing mode selection section 350, a compression processing selection section 352, an image capturing frame rate acquisition section 354, a video file generation section 360, and a recording section 370.

The video acquisition section 302 is a part that acquires image data of frames constituting a video 300 captured by a video capturing section. The video acquisition section 302 acquires video data having a variable image capturing frame rate in response to a command to change the image capturing frame rate during the video capturing.

The user can select and set a desired image capturing frame rate using the menu screen for setting the image capturing frame rate before the start of the video capturing. The user can change the image capturing frame rate by operating the operation section 222 or the like even during the video capturing. The image capturing frame rate is not limited to the case where the image capturing frame rate is changed by the user instruction, and may be automatically changed by detecting a case where a moving object is detected during the video capturing, a case where a scene change occurs, or the like.

The compression processing section 208A in the compression/expansion processing section 208 is mainly composed of an orthogonal transformer 310, a quantization section 320, an encoding section 330, and a bit rate control section 340. In the compression processing section 208A of the present example, the compression is performed by the H.264/AVC method, which is one of the MPEG encoding methods.

In the MPEG compression method, compression, editing, and the like are performed in a one group of pictures (GOP) unit, which is a set of several frames (for example, 15 frames) of a video. The one GOP includes an intra (I) frame in which only information of its own frame is compressed and correlation information with other temporally preceding and following frames is not used, a predictive (P) frame represented by correlation information from a temporally past frame, and a bidirectionally (B) frame represented by correlation information from temporally preceding and following frames. A head frame of the one GOP is at least the I-frame.

In this example, in order to simplify the description, it is assumed that the video acquisition section 302 sequentially acquires the I-frame, the P-frame, and the B-frame constituting one GOP.

Each frame constituting the one GOP is encoded in a macroblock unit of 16×16 pixels. The brightness data Y and the color difference data Cb and Cr of one macroblock are, for example, converted into four blocks of brightness data Y of 8×8 pixels in a format of Y:Cr:Cb=4:1:1 and one block of color difference data Cr and Cb each thinned out to 8×8 pixels, and then quantization processing is performed for each block (unit block).

The orthogonal transformer 310 orthogonally transforms data of a unit block of 8×8 pixels according to a method called discrete cosine transform (DCT) to decompose the data into a frequency component and calculates an orthogonal transform coefficient.

The quantization section 320 quantizes the orthogonal transform coefficient transformed by the orthogonal transformer 310 based on a quantization parameter (QP) value (QP value) determined (set) by the bit rate control section 340.

In the H.264/AVC, the QP value is defined in a range of 0 to 51. In a case where the QP value is determined within this range, a quantization step size (Qₛₜₑₚ) corresponding to the QP value is determined. The Qₛₜₑₚ is a value that divides the orthogonal transform coefficient performed in the quantization processing. In the H.264/AVC, the Qₛₜₑₚ is a value that doubles in a case where the QP value increases by 6 and can be derived using a lookup table or by calculation based on the determined QP value.

Quality and a bit rate of a compressed bit stream are mainly determined by the QP value selected to quantize each macroblock. The Qₛₜₑₚ corresponding to the QP value is a numerical value for adjusting how much spatial detail is held in the compressed macroblock.

The smaller the Qₛₜₑₚ, the more detail is held and the better the image quality, but the higher the bit rate. As the Qₛₜₑₚ increases, less detail is held and the bit rate is reduced, but the image quality deteriorates. Therefore, the bit rate control section 340 needs to determine the QP value (Qₛₜₑₚ) in consideration of the image quality and the bit rate. A method of determining the QP value by the bit rate control section 340 will be described below.

The encoding section 330 is a part that entropy-encodes a quantization value supplied from the quantization section 320. In the H.264/AVC, it is possible to select any one of variable length coding (VLC) based on Huffman code or arithmetic coding. Compressed data (encoded data) further compressed by the encoding section 330 is transmitted to the video file generation section 360 as the bit stream.

The video file generation section 360 generates a video file from the compressed data of the video compressed by the compression processing section 208A, and outputs the generated video file to the recording section 370. The recording section 370 records the input video file on the recording medium 380.

The media control section 210 functions as the video file generation section 360 and the recording section 370. The recording medium 380 includes the memory card 212 or the internal memory of the camera body 200 (for example, flash ROM 226).

It is preferable that the video file generation section 360 divides the video for each change in the image capturing frame rate to create a plurality of video files in the case of a video compressed by second compression processing according to the change in the image capturing frame rate and creates one video file in the case of a video compressed by first compression processing regardless of the change in the image capturing frame rate.

In the former case, a video file for the static image extraction can be selected from the plurality of video files divided according to the change in the image capturing frame rate. Accordingly, it is possible to efficiently extract a desired frame. In the latter case, it is possible to continuously play back a video of one video capturing period (video from the start to the end of video capturing).

It is preferable that the recording section 370 records the plurality of video files created from the video compressed by the second compression processing in different storage regions of the recording medium 380 or in different recording media. The different recording media are, for example, the recording medium 380 and the internal memory, and a plurality of recording media attached to a plurality of card slots in a case where the recording section 370 has the plurality of card slots.

The bit rate control section 340 has a function as a video buffering verifier (VBV) buffer, acquires encoded data (generated code amount) after the quantization of the image data of the past frame of the video output from the encoding section 330, for example, in the macroblock unit, calculates a VBV buffer occupation amount from the acquired generated code amount and a set bit rate of the bit stream set in advance to determine a QP value at which the VBV buffer does not fail. The bit rate control section 340 outputs the determined QP value to the quantization section 320.

The bit rate control section 340 may output the quantization step size (Qₛₜₑₚ) corresponding to the QP value to the quantization section 320 instead of the determined QP value. The bit rate control section 340 may determine the QP value in frame unit or GOP unit.

The quantization section 320 acquires the Qₛₜₑₚ corresponding to the QP value input from the bit rate control section 340 or directly acquires the Qₛₜₑₚ from the bit rate control section 340 and divides the orthogonal transform coefficient by the Qₛₜₑₚ to calculate the quantization value rounded to an integer.

Next, a method of determining the QP value by the bit rate control section 340 will be described in further detail.

The compression processing selection section 352 shown in FIG. 4 is a part that selects the first compression processing or the second compression processing. An image capturing mode command indicating the first video capturing mode for the normal video or the second video capturing mode for the static image extraction is added to the compression processing selection section 352 from the image capturing mode selection section 350.

Here, in the second compression processing, the change in a capacity per unit time is set to be large and the change in a capacity per frame is set to be small with respect to the change in the image capturing frame rate, as compared with in the first compression processing. Therefore, since the change in the capacity per unit time is small with respect to the change in the image capturing frame rate in the first compression processing as compared with the second compression processing, it is possible to suppress the increase and decrease in the capacity (priority is given to the capacity). On the other hand, since the change in the capacity per frame is small with respect to the change in the image capturing frame rate in the second compression processing as compared with in the first compression processing, it is possible to suppress a variation in the image quality of the frames constituting the video even though the image capturing frame rate changes (priority is given to the image quality).

In a case where the static image is extracted from the video, one static image may be generated by using the plurality of frames for the purpose of focus stacking, noise reduction, and the like. In the second video capturing mode for the static image extraction, the static image is generated using the frame before the frame rate change and the frame after the frame rate change by suppressing the variation in the image quality of the frames with respect to the change in the frame rate.

In the present example, the image capturing mode selection section 350 is an on-screen interactive operation section that uses the MENU/OK key 27, the cross key 28, the liquid crystal monitor 216, and the like, but may be a mode dial for selecting the various image capturing modes.

The compression processing selection section 352 selects the first compression processing that prioritizes the capacity in a case where the first video capturing mode is selected by the image capturing mode selection section 350, selects the second compression processing that prioritizes the image quality in a case where the second video capturing mode is selected by the image capturing mode selection section 350, and outputs the selection result to the bit rate control section 340. As described above, in a case where the first video capturing mode or the second video capturing mode is selected by the image capturing mode selection section 350, the image capturing condition is set according to each video capturing mode and the video is captured.

The image capturing frame rate acquisition section 354 acquires the image capturing frame rate set before the start of the video capturing and the image capturing frame rate manually or automatically changed during the video capturing and outputs frame rate information indicating the acquired image capturing frame rate to the bit rate control section 340. In this example, the image capturing frame rate that can be set and changed is any one of 15 fps (frames per second), 30 fps, 60 fps, or 120 fps, but the present invention is not limited thereto.

The compression processing section 208A executes the first compression processing or second compression processing selected by the compression processing selection section 352 for the video having the variable image capturing frame rate. Specifically, the bit rate control section 340 sets the bit rate based on information indicating the first compression processing or second compression processing selected by the compression processing selection section 352 and a current image capturing frame rate acquired by the image capturing frame rate acquisition section 354.

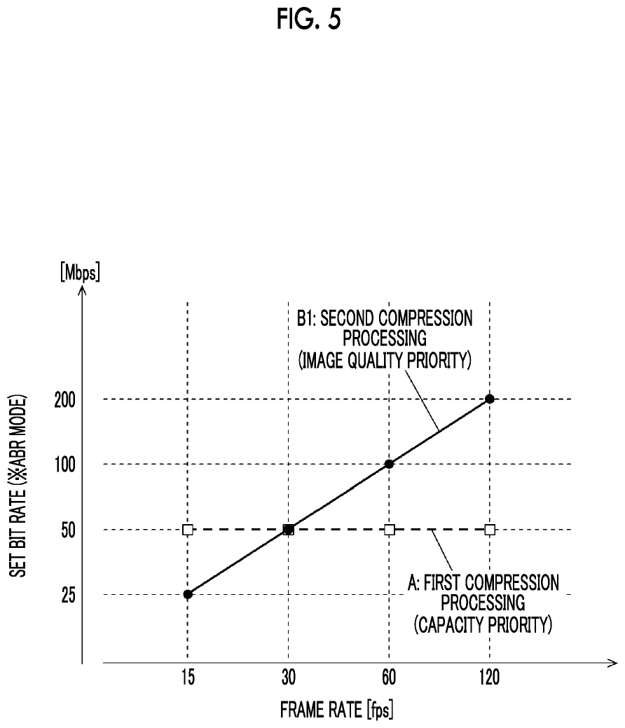

FIG. 5 is a graph showing a first example of the set bit rate set based on the first compression processing or the second compression processing and the image capturing frame rate.

In the first example shown in FIG. 5, in a case where the first compression processing is selected, the set bit rate is set to a constant bit rate (50 [Mbps] (mega bits per second) in this example) as indicated by a dotted line graph A, regardless of the change in the image capturing frame rate.

In the first compression processing, the set bit rate is constant regardless of the change in the image capturing frame rate. Therefore, for example, in a case where the image capturing frame rate changes to 2 times, 4 times, . . . , a compression rate is also set to be changed to 2 times, 4 times, . . . . That is, in the first compression processing, the capacity of the compressed video becomes substantially constant (priority is given to the capacity) with respect to the change in the image capturing frame rate, but the compression rate varies significantly and the image quality changes.

On the other hand, in a case where the second compression processing is selected, as indicated by a solid line graph B1, in a case where the image capturing frame rate changes to 2 times, 4 times, . . . , the set bit rate is also set to be changed to 2 times, 4 times, . . . . That is, in the second compression processing, the compression rate becomes substantially constant (priority is given to the image quality) with respect to changes in the image capturing frame rate, but the capacity of the compressed video varies significantly.

The bit rate control includes a constant bit rate (CBR) mode, an average bit rate (ABR) mode, and a variable bit rate (VBR) mode. In this example, ABR mode is applied. The present invention is not limited to the ABR mode, and the bit rate control in the CBR mode or the VBR mode is also possible.

Next, the bit rate control by the ABR mode of this example will be described.

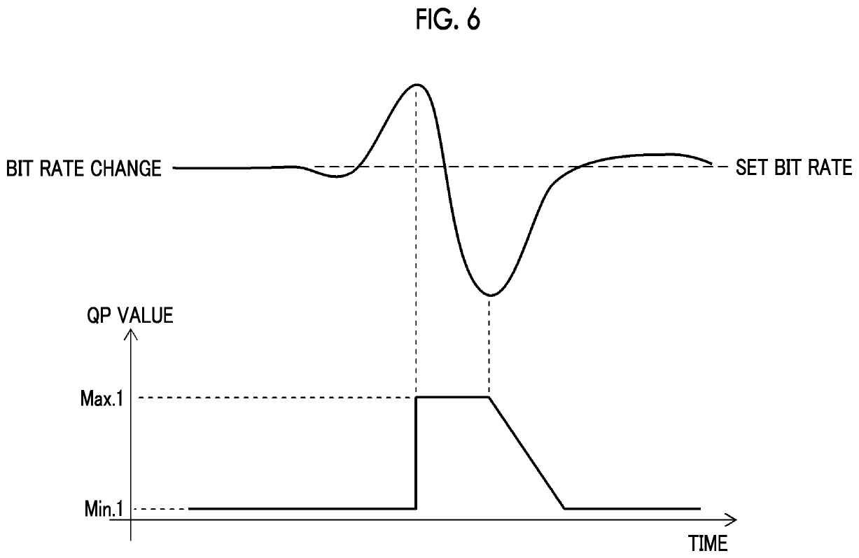

FIG. 6 is a schematic diagram showing a relationship between a change in the generated code amount (bit rate) after the quantization of the image data of the past frame and the QP value in the case where the compression processing is performed on the video.

As shown in FIG. 6, the bit rate control section 340 determines the QP value used for the quantization of the video within a range between a lower limit value (Min.1) and an upper limit value (Max.1). In the case of H.264/AVC, a maximum range that the QP value can take is 0 to 51, but Min.1 and Max.1 are set in consideration of the compression rate and the image quality of the video.

As shown in FIG. 6, in a case where the QP value is set to Min.1, in a case where a frame or a GOP of a moving scene such as the scene change is quantized, the generated code amount after the quantization increases rapidly. In this case, the bit rate control section 340 increases the QP value such that the VBV buffer does not fail (the VBV buffer occupation amount overflows).

In the example shown in FIG. 6, in a case where the generated code amount increases rapidly, the QP value is changed from Min.1 to Max.1.

Thereafter, in a case where the scene changes from the moving scene to a static scene, the generated code amount after the quantization is rapidly reduced since the QP value is held at Max.1. The bit rate control section 340 reduces the QP value such that the VBV buffer does not fail (the VBV buffer occupation amount underflows) due to the reduction in the generated code amount.

In the ABR mode, the QP value is determined as described above such that the average bit rate becomes the set bit rate (target bit rate). The set bit rate is appropriately set as shown in the graph of FIG. 5 according to whether the first compression processing or the second compression processing is performed and the image capturing frame rate.

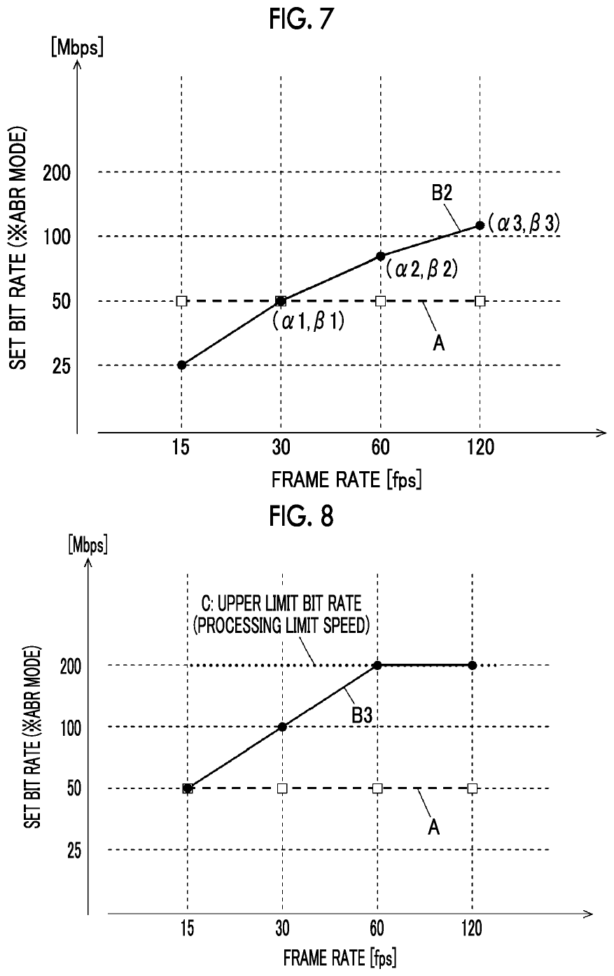

FIG. 7 is a graph showing a second example of the set bit rate set based on the first compression processing or the second compression processing and the image capturing frame rate.

In the second example shown in FIG. 7, in the case where the first compression processing is selected, the set bit rate is set to a constant bit rate indicated by the dotted line graph A regardless of the change in the image capturing frame rate as in the first example shown in FIG. 5.

On the other hand, in the case where the second compression processing is selected, the set bit rate is set to be increased according to the increase in the image capturing frame rate as the image capturing frame rate increases as indicated by a solid line graph B2. A rate of increase in the set bit rate is set to be lower as the image capturing frame rate is higher.

In a case where the set bit rate in a case where the image capturing frame rate is 30 fps (first frame rate=α1) is β1 (50 [Mbps]), the set bit rate in a case where the image capturing frame rate is 60 fps (second frame rate=α2) is β2, and the set bit rate in a case where the image capturing frame rate is 120 fps (third frame rate=α3) is β3, the set bit rate in the second compression processing is set to satisfy the following expression (1).

(β2−β1)/(α2−α1)>(β3−β2)/(α3−α2) (1).

As shown in graph B2 of FIG. 7 and expression (1), the reason why the rate of increase in the set bit rate is set to be lower as the image capturing frame rate is higher is that it is expected that there is less change between adjacent frames of the video in a case where the image capturing frame rate is high, as compared with a case where the image capturing frame rate is low, and thus the compression maintaining the image quality is possible even though the rate of increase in the set bit rate is lowered.

FIG. 8 is a graph showing a third example of the set bit rate set based on the first compression processing or the second compression processing and the image capturing frame rate.

In the third example shown in FIG. 8, in the case where the first compression processing is selected, the set bit rate is set to the constant bit rate indicated by the dotted line graph A regardless of the change in the image capturing frame rate as in the first example shown in FIG. 5.

On the other hand, in the case where the second compression processing is selected, the set bit rate is set to be changed to 2 times, 4 times, . . . , in a case where the image capturing frame rate changes to 2 times, 4 times, . . . , as indicated by a solid line graph B3. However, in a case where the set bit rate reaches an upper limit bit rate (processing limit speed of the image processing device and 200 [Mbps] in this example) C, the set bit rate is fixed to the upper limit bit rate C. In this example, since the upper limit bit rate C is reached in a case where the image capturing frame rate is 60 fps, the set bit rate is set to the upper limit bit rate C even in a case where the image capturing frame rate changes from 60 fps to 120 fps.

As shown in FIGS. 5, 7, and 8, in a case where the image capturing frame rate is the first frame rate (30 fps), the set bit rate of the second compression processing is set to be equal to or higher than the set bit rate of the first compression processing, and an amount of change in the set bit rate in a case where the image capturing frame rate changes from the first frame rate to the second frame rate having larger frame rate than the first frame rate is set to be larger in the second compression processing than that in the first compression processing.

In the graphs B1 and B2 of FIGS. 5 and 7, in a case where the frame rate is 15 fps, the set bit rate ([25 Mbps]) smaller than the set bit rate (50 [Mbps]) indicated by the graph A is set, but the present invention is not limited thereto. The lower limit value of the set bit rate of the second compression processing may be set to the set bit rate of the first compression processing such that the set bit rate of the second compression processing is not smaller than the set bit rate of the first compression processing.

In the second video capturing mode in which the image quality is prioritized, the set bit rate is set such that the image quality per image does not change even in a case where the frame rate is changed. However, in another aspect, the image quality per image may be set to be improved in the case where the frame rate is changed. Specifically, in the second compression processing, the set bit rate is set to be changed to 2 times or more, 4 times or more, . . . , in a case where the image capturing frame rate changes to 2 times, 4 times, . . . , with respect to an initial frame rate, and the set bit rate is set to be changed to ½ times or more, ¼ times or more, . . . , in a case where the image capturing frame rate changes to ½ times, ¼ times, . . . . Accordingly, for example, during video capturing for the static image extraction, it is possible to perform the image capturing with a suppressed capacity of the compressed video until the set frame rate is changed by the user instruction, the event detection, or the like and perform the image capturing with high image quality after a time at which the set frame rate is changed.

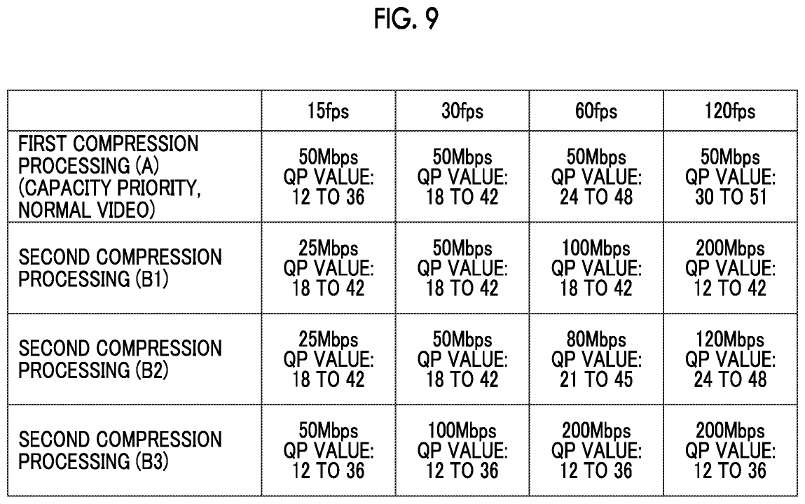

FIG. 9 is a table showing a range of the set bit rate set based on the first compression processing or the second compression processing and the image capturing frame rate and the QP value.

As shown in FIG. 9, the set bit rate is set as indicated by the graphs A, B1, B2, and B3 of FIGS. 5, 7, and 8.

In the range of the QP value used for the first compression processing, the upper limit value and the lower limit value of the QP value are increased by 6 each as the image capturing frame rate is changed by 2 times. This is because in the H.264/AVC method compression processing, the compression rate increases about 2 times in a case where the QP value increases by 6. The upper limit value of the QP value in a case where the image capturing frame rate is 120 fps is 51, and an upper limit value (48) thereof in a case where the image capturing frame rate is 60 fps is not increased by 6. This is because a maximum value of the QP value is 51 in the H.264/AVC method compression processing.

The range of the QP value used for the second compression processing of the set bit rate of the first example (graph B1 in FIG. 5) is constant (18 to 42) regardless of the image capturing frame rate. Similarly, the range of the QP value used for the second compression processing of the set bit rate of the third example (graph B3 in FIG. 8) is also constant regardless of the image capturing frame rate. However, the upper limit value and the lower limit value of the QP value are each decreased by 6 (12 to 36), as compared with the case of the graph B1 in FIG. 5.

The range of the QP value used for the second compression processing of the set bit rate of the second example (graph B2 in FIG. 7) is the same as the range of the QP value used for the second compression processing of the set bit rate of the first example (graph B1 in FIG. 5) in a case where the image capturing frame rates are 15 fps and 30 fps. However, in a case where the image capturing frame rates are 60 fps and 120 fps, the upper limit value and the lower limit value of the QP value are each slightly larger than the range of the QP value used for the second compression processing of the set bit rate of the first example (graph B1 in FIG. 5). This is because in a case where the image capturing frame rate is high, the compression maintaining the image quality is possible even though the rate of increase in the set bit rate is lowered (even though the compression rate is increased), as compared with the case where the image capturing frame rate is low, as described above.

### Second Embodiment

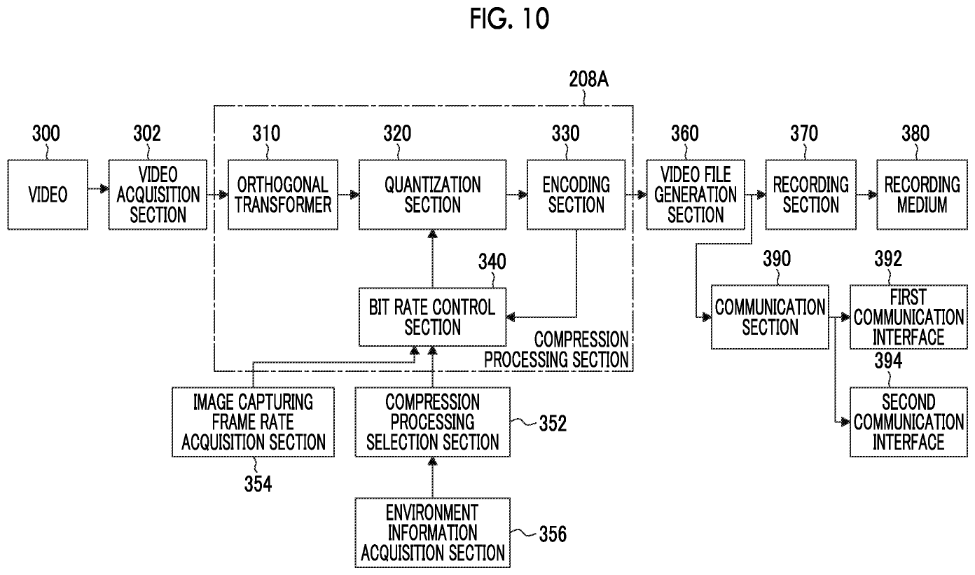

FIG. 10 is a block diagram showing a second embodiment of the image processing device according to the present invention. In the second embodiment shown in FIG. 10, the same reference numeral is assigned to a part common to that of the first embodiment shown in FIG. 4 and detailed description thereof will be omitted.

The image processing device of the second embodiment shown in FIG. 10 is provided with an environment information acquisition section 356 instead of the image capturing mode selection section 350 of the image processing device of the first embodiment shown in FIG. 4, a communication section 390, a first communication interface 392, and a second communication interface 394.

The communication section 390 includes a wired communication section in addition to the wireless communication section 236 that performs wireless communication such as Wi-Fi and Bluetooth. The first communication interface 392 and the second communication interface 394 are a plurality of types of communication interfaces such as a high-definition multimedia interface (HDMI) (registered trademark), which is a standard for a communication interface for transmitting video, voice, or the like as a digital signal, and a universal serial bus (USB), which is a general-purpose interface standard for connecting to an external device.

The video file generated by the video file generation section 360 can be transferred from the first communication interface 392 or the second communication interface 394 to an external device through the communication section 390.

The first communication interface 392 of this example is a communication interface that does not have a transfer speed required for transferring the video file compressed by the second compression processing, and for example, Wi-Fi having slow communication can be considered. The second communication interface 394 is a communication interface having the transfer speed required for transferring the video file compressed by the second compression processing, and for example, HDMI and USB having fast communication can be considered.

The recording medium 380 is a first recording medium (for example, a low-speed writable secure digital (SD) memory card of ultra high speed (UHS) 1) that does not have the transfer speed required for recording the video file of the video compressed by the second compression processing or a second recording medium (for example, a high-speed writable SD memory card of UHS 2 and an XQD memory card (XQD is a registered trademark)) having the transfer speed required for recording the video file of the video compressed by the second compression processing. The recording section 370 has the plurality of card slots and includes a section capable of appropriately selecting the recording medium and recording the video file for the plurality of recording media attached to the plurality of card slots.

The environment information acquisition section 356 acquires environment information indicating the environment of the device connected to the video file generation section 360 and outputs the acquired environment information to the compression processing selection section 352.

The environment of the device connected to the video file generation section 360 is any one of transfer speeds of the recording medium 380 connected to the video file generation section 360 through the recording section 370 or the communication interfaces (the first communication interface 392 and the second communication interface 394) connected to the video file generation section 360 through the communication section 390. The environment information acquisition section 356 acquires such information as the environment information.

The compression processing selection section 352 selects the first compression processing or the second compression processing according to the environment information input from the environment information acquisition section 356.

The compression processing selection section 352 selects the first compression processing in a case where the recording section 370 records the video file on the first recording medium that does not have the transfer speed required for recording the video file of the video compressed by the second compression processing and the second compression processing in a case where the recording section 370 records the video file on the second recording medium having the transfer speed required for recording the video file of the video compressed by the second compression processing. That is, the compression processing selection section 352 selects the first compression processing or the second compression processing according to a writing speed of the recording medium of the recording destination of the video file.

The compression processing selection section 352 selects the first compression processing in a case where the communication section 390 transfers the video file through the first communication interface 392 that does not have the transfer speed required for transferring the video file of the video compressed by the second compression processing and the second compression processing in a case where the communication section 390 transfers the video file through the second communication interface 394 having the transfer speed required for transferring the video file of the video compressed by the second compression processing. That is, the compression processing selection section 352 selects the first compression processing or the second compression processing according to the transfer speed of the communication interface for transferring the video file.

Further, the compression processing selection section 352 selects the second compression processing that gives priority to the image quality in a case where a remaining capacity of the recording medium 380 on which the video file is recorded by the recording section 370 is a capacity required for recording the video file of the video compressed by the second compression processing and the first compression processing that gives priority to the capacity in a case where there is no capacity required for recording the video file of the video compressed by the second compression processing.

### Third Embodiment

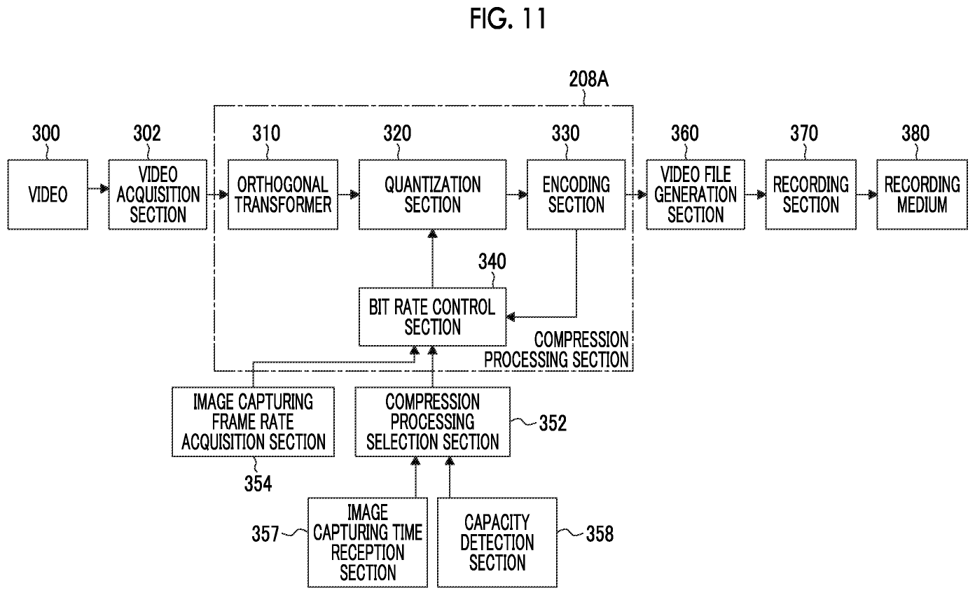

FIG. 11 is a block diagram showing a third embodiment of the image processing device according to the present invention. In the third embodiment shown in FIG. 11, the same reference numeral is assigned to a part common to that of the first embodiment shown in FIG. 4 and detailed description thereof will be omitted.

The image processing device of the third embodiment shown in FIG. 11 is provided with an image capturing time reception section 357 and a capacity detection section 358 instead of the image capturing mode selection section 350 of the image processing device of the first embodiment shown in FIG. 4.

The MENU/OK key 27, the cross key 28, and the liquid crystal monitor 216 function as the image capturing time reception section 357 that receives the image capturing time of the video, and the user can use the menu screen or the like at the start of capturing the video to set the image capturing time of the video.

The image capturing time reception section 357 outputs information indicating the image capturing time of the received video to the compression processing selection section 352.

The capacity detection section 358 detects the remaining capacity of the recording medium 380 and outputs information indicating the detected remaining capacity to the compression processing selection section 352. The remaining capacity of the recording medium 380 detected by the capacity detection section 358 is a kind of the environment information indicating the environment of the device connected to the video file generation section 360, and the capacity detection section 358 is a form of the environment information acquisition section 356 shown in FIG. 10.

The compression processing selection section 352 selects the first compression processing or the second compression processing based on the image capturing time of the video received by the image capturing time reception section 357 and the remaining capacity of the recording medium 380 detected by the capacity detection section 358. That is, the compression processing selection section 352 selects the first compression processing that gives priority to the capacity in a case where the remaining capacity of the recording medium 380 is less than the capacity required for recording the video file compressed by the second compression processing and the second compression processing that gives priority to the image quality in a case where the remaining capacity of the recording medium 380 is equal to or larger than the capacity required for recording the video file compressed by the second compression processing, during the image capturing time of the video.

The compression processing selection section 352 may select the first compression processing of capacity priority in a case where the remaining capacity of the recording medium 380 is less than a capacity set in advance and the second compression processing of image quality priority in a case where the remaining capacity of the recording medium 380 is equal to or larger than the capacity set in advance. In this case, the image capturing time reception section 357 is unnecessary.

### Image Processing Method

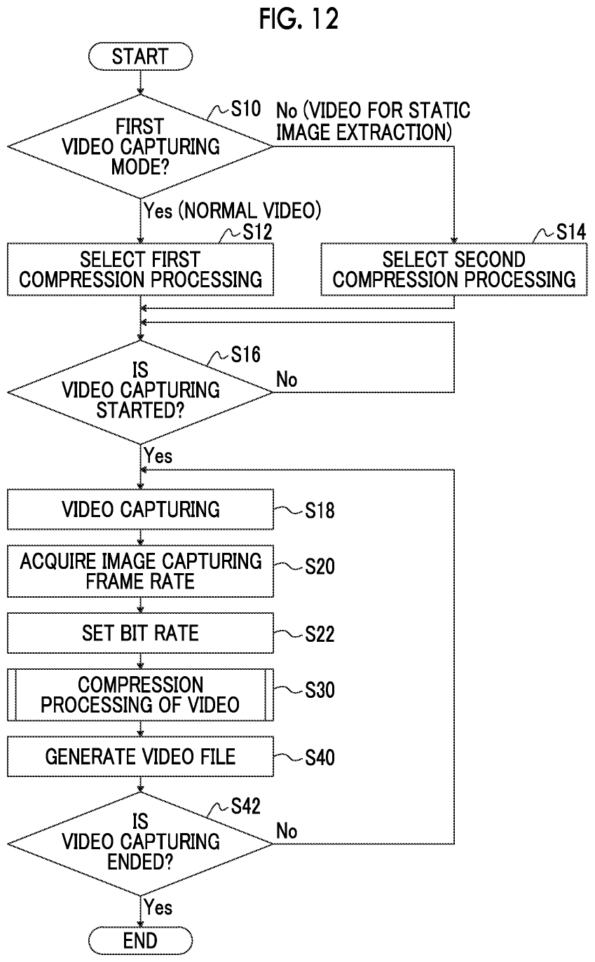

FIG. 12 is a flowchart showing an embodiment of the image processing method according to the present invention and shows a processing operation of the image processing device of the first embodiment shown in FIG. 4.

In FIG. 12, the compression processing selection section 352 discriminates whether the first video capturing mode for the normal video or the second video capturing mode for the static image extraction is selected based on the selection result by the image capturing mode selection section 350 (step S10).

The compression processing selection section 352 selects the first compression processing in a case where the first video capturing mode is selected (step S12) and the second compression processing in a case where the first video capturing mode is not selected (in the case of “No”) (step S14).

Subsequently, the body-side CPU 220 of the image capturing device 10 discriminates whether or not the video capturing is started based on an input signal from the operation section 222 (shutter release switch 22) (step S16).

In a case where discrimination is made that the video capturing is started in step S16, the body-side CPU 220 controls the interchangeable lens 100, the image sensor 201, and the like that function as the video capturing section to perform the video capturing in the first video capturing mode or the second video capturing mode (step S18).

The image capturing frame rate acquisition section 354 acquires the image capturing frame rate set before the start of the video capturing and the image capturing frame rate changed manually or automatically during the video capturing (step S20).

The bit rate control section 340 of the compression processing section 208A sets the bit rate as described with reference to FIG. 5 and the like based on the information of the first compression processing or second compression processing selected by the compression processing selection section 352 and the current image capturing frame rate acquired by the image capturing frame rate acquisition section 354 (step S22).

The compression processing section 208A performs the compression processing of the video according to the set bit rate (step S30).

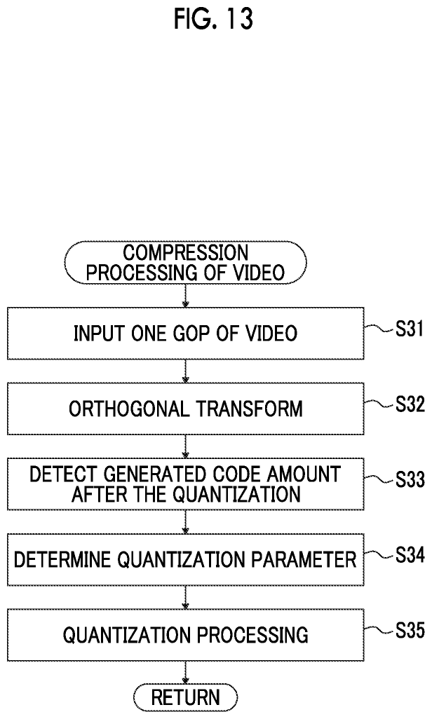

FIG. 13 is a flowchart showing details of the compression processing of the video in step S30 of FIG. 12.

In FIG. 13, the captured video is compressed or the like in the one GOP unit by the H.264/AVC method, which is one of the MPEG encoding methods. That is, in a case where the video capturing is started, the video acquisition section 302 sequentially acquires each frame (I-frame, P-frame, and B-frame constituting one GOP) of the normal video or the video for the static image extraction (step S31).

For each frame, the compression processing is performed for each unit block of 8×8 pixels. The orthogonal transformer 310 performs the discrete cosine transform (DCT) on the data of the unit block to calculate the orthogonal transform coefficient (step S32).

The bit rate control section 340 having a function as the VBV buffer acquires the encoded data (the generated code amount after the quantization of the image data of the past frame of the video) output from the encoding section 330, for example, in the macroblock unit (step S33). The bit rate control section 340 calculates the VBV buffer occupation amount from the acquired generated code amount and the set bit rate set in step S22 of FIG. 12 to determine the quantization parameter (QP value) at which the VBV buffer does not fail (step S34).

The quantization section 320 divides the orthogonal transform coefficient input from the orthogonal transformer 310 by the quantization step size (Qₛₜₑₚ) corresponding to the QP value determined by the bit rate control section 340 to calculate the quantization value rounded to an integer. The calculated quantized value is entropy-encoded by the encoding section 330 and output to the video file generation section 360 (FIG. 4) as the bit stream of the compressed data (step S35).

Returning to FIG. 12, the video file generation section 360 generates the video file of the compressed data output from the compression processing section 208A (step S40).

Subsequently, the body-side CPU 220 of the image capturing device 10 discriminates whether or not the video capturing ends based on the input signal from the operation section 222 (step S42). In a case where discrimination is made that the video capturing does not end (in the case of “No”), the processing proceeds to step S18. Accordingly, the video capturing, the compression processing, the recording processing, and the like are continuously performed. In a case where discrimination is made that the video capturing ends (in a case of “Yes”), the image processing ends.

The method of selecting the first compression processing or the second compression processing is not limited to the embodiment shown in the flowchart of FIG. 12, and may be a selection method of performing the selection in the same manner as the image processing device shown in FIGS. 10 and 11.

The image capturing device 10 according to the present embodiment is the mirrorless digital single-lens camera, but is not limited thereto and may be a single-lens reflex camera, a lens-integrated image capturing device, a digital video camera, or the like. The image capturing device 10 is also applicable to a mobile device having functions (calling function, communication function, and other computer functions) other than the image capturing, in addition to the image capturing function. Examples of another aspect to which the present invention can be applied include a portable phone or smartphone having a camera function, a personal digital assistant (PDA), and a portable game machine. Hereinafter, an example of the smartphone to which the present invention can be applied will be described.

### Configuration of Smartphone

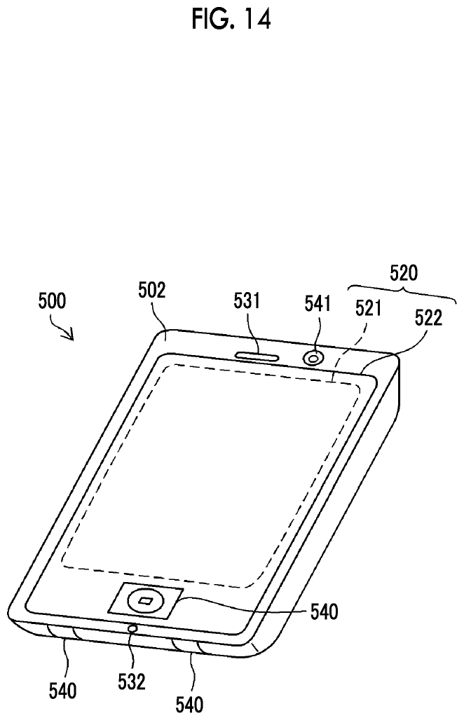

FIG. 14 shows an appearance of a smartphone 500 which is another embodiment of the image capturing device of the present invention. The smartphone 500 shown in FIG. 14 has a flat housing 502 and comprises a display and input section 520 in which the display panel 521 as a display section and an operation panel 522 as an input section are integrated on one surface of the housing 502. The housing 502 comprises a speaker 531, a microphone 532, an operation section 540, and a camera section 541. A configuration of the housing 502 is not limited thereto. For example, a configuration in which the display section and the input section are independent or a configuration having a folding structure or a slide mechanism can be employed.

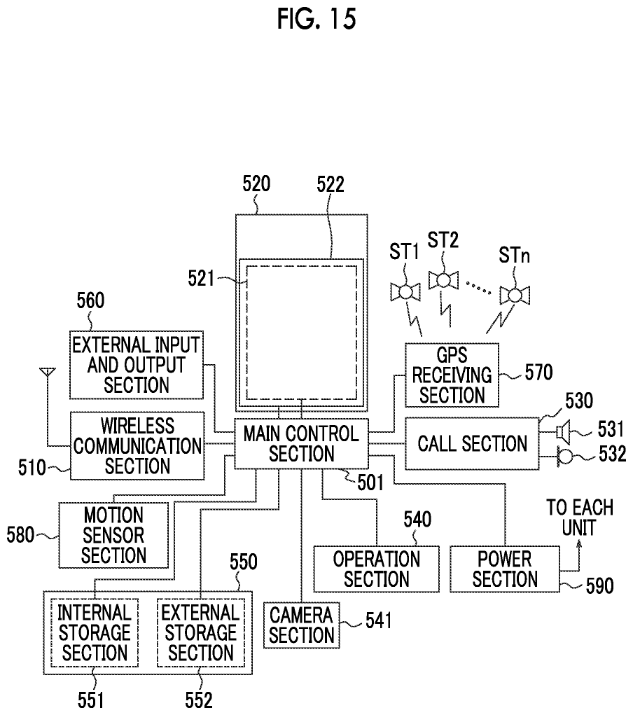

FIG. 15 is a block diagram showing a configuration of the smartphone 500 shown in FIG. 14. As shown in FIG. 15, a wireless communication section 510 that performs mobile wireless communication through a base station and a mobile communication network, the display and input section 520, a call section 530, the operation section 540, the camera section 541, the recording section 550, an external input and output section 560, a global positioning system (GPS) receiving section 570, a motion sensor section 580, a power section 590, and the main control section 501 are provided as main components of the smartphone.

The wireless communication section 510 performs the wireless communication with the base station accommodated in the mobile communication network in response to an instruction from the main control section 501. This wireless communication is used to transmit and receive various pieces of file data such as voice data and image data, e-mail data, and the like, and receive Web data, streaming data, and the like.

The display and input section 520 is a so-called touch panel in which the image (static image and video), character information, or the like is displayed to visually transmit information to the user and a user operation on the displayed information is detected under control of the main control section 501, and comprises a display panel 521 and an operation panel 522.

The display panel 521 uses a liquid crystal display (LCD), an organic electro-luminescence display (OELD), or the like as the display device. The operation panel 522 is a device that is placed such that an image displayed on a display surface of the display panel 521 is visually recognizable and that detects one or a plurality of coordinates operated by a finger of the user or a stylus. In a case where such a device is operated by the finger of the user or the stylus, a detection signal generated due to the operation is output to the main control section 501. Next, the main control section 501 detects an operation position (coordinates) on the display panel 521 based on the received detection signal.

As shown in FIG. 14, although the display panel 521 and the operation panel 522 of the smartphone 500 exemplified as an embodiment of the image capturing device according to the present invention integrally constitute the display and input section 520, the operation panel 522 is disposed so as to completely cover the display panel 521. In a case where such a disposition is employed, the operation panel 522 may comprise a function of detecting the user operation even in a region outside the display panel 521. In other words, the operation panel 522 may comprise a detection region (hereinafter referred to as display region) for an overlapping portion that overlaps the display panel 521 and a detection region (hereinafter referred to as non-display region) for an outer edge portion, which is other than the detection region, that does not overlap the display panel 521.

A size of the display region and a size of the display panel 521 may be perfectly matched, but the sizes are not necessarily matched. The operation panel 522 may comprise two sensitive regions of the outer edge portion and the other inner portion. Further, a width of the outer edge portion is designed as appropriate according to a size of the housing 502 or the like. Furthermore, examples of a position detection method employed in the operation panel 522 include a matrix switch method, a resistive film method, a surface acoustic wave method, an infrared method, an electromagnetic induction method, and an electrostatic capacitive method, and any method may be employed.

The call section 530 comprises the speaker 531 and the microphone 532. The call section 530 converts a voice of the user input through the microphone 532 into voice data that can be processed by the main control section 501 and outputs the converted voice data to the main control section 501, or decodes the voice data received by the wireless communication section 510 or the external input and output section 560 and outputs the decoded voice data from the speaker 531. As shown in FIG. 14, it is possible to mount the speaker 531 and the microphone 532 on the same surface as a surface on which the display and input section 520 is provided.

The operation section 540 is a hardware key using a key switch or the like and receives the instruction from the user. For example, as shown in FIG. 14, the operation section 540 is a push-button type switch that is mounted on a side surface of the housing 502 of the smartphone 500, is turned on in a case of being pressed with a finger or the like, and is turned off by restoring force of a spring or the like in a case where the finger is released.

The recording section 550 stores a control program or control data of the main control section 501, application software (including the image processing program according to the present invention), address data in which a name, a telephone number, and the like of a communication partner are associated, data of transmitted and received e-mails, Web data downloaded by Web browsing, or downloaded content data, and temporarily stores streaming data or the like. The recording section 550 is composed of an internal storage section 551 built into the smartphone and an external storage section 562 having an attachable and detachable external memory slot. Each of the internal storage section 551 and the external storage section 552 constituting the recording section 550 is formed by using a recording medium such as a flash memory type, a hard disk type, a multimedia card micro type, a card type memory (for example, MicroSD (registered trademark) memory or the like), a random access memory (RAM), or a read only memory (ROM).

The external input and output section 560 serves as an interface with all external devices connected to the smartphone 500, and is for directly or indirectly connecting to another external device by communication or the like (for example, universal serial bus (USB), IEEE1394, or the like) or by a network (for example, Internet, wireless local area network (LAN), Bluetooth (registered trademark), radio frequency identification (RFID), infrared communication (infrared data association: IrDA) (registered trademark), ultra wideband (UWB) (registered trademark), ZigBee (registered trademark), or the like).

Examples of the external device connected to the smartphone 500 include a wired/wireless headset, a wired/wireless external charger, a wired/wireless data port, a memory card or a subscriber identity module (SIM)/user identity module (UIM) card connected through a card socket, external audio and video devices connected through audio and video input and output (I/O) terminals, wirelessly connected external audio and video devices, a wired/wirelessly connected smartphone, a wired/wirelessly connected personal computer, a wired/wirelessly connected PDA, and an earphone. The external input and output section can transmit the data transmitted from such an external device to each component inside the smartphone 500 or can transmit the data inside the smartphone 500 to the external device.

The GPS receiving section 570 receives GPS signals transmitted from GPS satellites ST1 to STn in response to the instruction from the main control section 501 and executes positioning calculation processing based on the plurality of received GPS signals to detect a position of the smartphone 500 (latitude, longitude, and altitude). In a case where position information can be acquired from the wireless communication section 510 or the external input and output section 560 (for example, wireless LAN), the GPS receiving section 570 can detect the position thereof using the position information.

The motion sensor section 580 comprises, for example, a triaxial acceleration sensor and a gyro sensor, and detects a physical movement of the smartphone 500 in response to the instruction from the main control section 501. With the detection of the physical movement of the smartphone 500, a moving direction or acceleration of the smartphone 500 is detected. The detection result is output to the main control section 501.

The power section 590 supplies electric power accumulated in a battery (not shown) to each section of the smartphone 500 in response to the instruction from the main control section 501.

The main control section 501 comprises a microprocessor and operates according to the control program or the control data stored in the recording section 550 to integrally control each section of the smartphone 500. The main control section 501 has a mobile communication control function for controlling each section of a communication system and an application processing function for performing voice communication or data communication through the wireless communication section 510.

The application processing function is realized by the main control section 501 operating according to the application software stored in the recording section 550. Examples of the application processing function include an infrared communication function that controls the external input and output section 560 to perform data communication with a counterpart device, an e-mail function that transmits and receives e-mail, a web browsing function that browses a Web page, and an image processing function that performs the compression processing according to the present invention.

The main control section 501 also has the image processing function such as displaying a video on the display and input section 520 based on the image data (data of static image or video) such as received data or downloaded streaming data. The image processing function means a function of the main control section 501 decoding the image data described above, performing the image processing on such a decoding result, and displaying an image on the display and input section 520.

Further, the main control section 501 executes display control for the display panel 521 and operation detection control for detecting the user operation through the operation section 540 and the operation panel 522.

With the execution of the display control, the main control section 501 displays an icon for activating the application software, a software key such as a scroll bar, or a window for creating an e-mail. The scroll bar is a software key for receiving an instruction to move a display portion of an image, such as a large image that does not fit in the display region of the display panel 521.

With the execution of the operation detection control, the main control section 501 detects the user operation through the operation section 540, receives an operation for an icon or an input of a character string in an input field of a window through the operation panel 522, or receives a request for scrolling the display image through the scroll bar.

Further, with the execution of the operation detection control, the main control section 501 determines whether the operation position for the operation panel 522 is the overlapping portion (display region) that overlaps the display panel 521 or the other outer edge portion (non-display region) that does not overlap the display panel 521, and has a touch panel control function for controlling the sensitive region of the operation panel 522 or a display position of the software key.

The main control section 501 can also detect a gesture operation for the operation panel 522 and execute a function set in advance according to the detected gesture operation. The gesture operation does not mean a conventional simple touch operation, but means an operation of drawing a trajectory with a finger or the like, designating a plurality of positions at the same time, or a combination of these to draw the trajectory about at least one from the plurality of positions.

The camera section 541 is a digital camera that performs the image capturing electronically using an image capturing element such as a complementary metal oxide semiconductor (CMOS) or a charge-coupled device (CCD), and corresponds to the image capturing device 10 shown in FIG. 1. The camera section 541 can compress the image data of the static image obtained by the image capturing by, for example, joint photographic coding experts group (JPEG) or compress the image data of the video by, for example, H.264/AVC, and record the compressed image data in the recording section 550 or output the compressed image data through the external input and output section 560 or the wireless communication section 510, under the control of the main control section 501. In the smartphone 500 shown in FIG. 14, the camera section 541 is mounted on the same surface as the display and input section 520, but the mounting position of the camera section 541 is not limited thereto. The camera section 541 may be mounted on a back surface of the display and input section 520, or a plurality of camera sections 541 may be mounted. In a case where the plurality of camera sections 541 are mounted, the camera sections 541 to be used for image capturing may be switched to perform image capturing independently, or the plurality of camera sections 541 may be used at the same time for image capturing.

The camera section 541 can be used for various functions of the smartphone 500. For example, it is possible to display the image acquired by the camera section 541 on the display panel 521 or use the image of the camera section 541 as one of operation inputs of the operation panel 522. In a case where the GPS receiving section 570 detects the position, it is possible to detect the position with reference to the image from the camera section 541. Further, it is possible to determine an optical axis direction of the camera section 541 of the smartphone 500 or a current use environment without using the triaxial acceleration sensor or in combination with the triaxial acceleration sensor (gyro sensor) with reference to the image from the camera section 541. Of course, it is possible to use the image from the camera section 541 in the application software.

In addition, the image data of the static image or the video can be recorded in the recording section 550 or be output through the external input and output section 560 or the wireless communication section 510, by adding the position information acquired by the GPS receiving section 570, voice information acquired by the microphone 532 (the voice information may be converted into text information by voice-text conversion by the main control section or the like), posture information acquired by the motion sensor section 580, and the like.

### Other

In this embodiment, the H.264/AVC encoding method is described as an example, but the present invention is not limited thereto. The present invention can be applied to a case where the compression is performed by other encoding methods such as MPEG-2 and MPEG-4.

A hardware structure of the processing unit that executes the various pieces of processing in the image processing device and the image capturing device according to the present invention is the following various processors. The various processors include, for example, a central processing unit (CPU) which is a general-purpose processor that executes software (program) to function as various processing units, a programmable logic device (PLD) which is a processor whose circuit configuration can be changed after manufacturing such as a field programmable gate array (FPGA), and a dedicated circuitry which is a processor having a circuit configuration specifically designed to execute specific processing such as an application specific integrated circuit (ASIC), and the like.

One processing unit may be composed of one of these various processors or may be composed of two or more processors of the same type or different types (for example, a plurality of FPGAs or a combination of CPU and FPGA). The plurality of processing units may be composed of one processor. As an example of constituting the plurality of processing units by one processor, first, there is a form in which one processor is composed of a combination of one or more CPUs and software, as represented by a computer such as a client or a server, and the one processor functions as the plurality of processing units. Second, there is a form in which a processor that realizes the functions of the entire system including the plurality of processing units by one integrated circuit (IC) chip is used, as represented by a system on chip (SoC) or the like. As described above, the hardware structure for the various processing units is composed of using one or more of the various processors described above.

Further, the hardware structure of the various processors is, more specifically, circuitry in which circuit elements such as semiconductor elements are combined.

Furthermore, the present invention includes the image processing program that is installed in the image capturing device to function as the image processing device or the image capturing device according to the present invention and the recording medium in which the image processing program is recorded.

It is needless to say that the present invention is not limited to the embodiments described above and various modifications can be made within a range not departing from the spirit of the present invention.

### EXPLANATION OF REFERENCES

10: image capturing device

20: view finder window

22: shutter release switch

23: shutter speed dial

24: exposure correction dial

25: power lever

26: eyepiece section

27: MENU/OK key

28: cross key

29: playback button

30: built-in flash

100: interchangeable lens

102: image capturing optical system

104: lens group

108: stop

116: focus lens control section

118: stop control section

120: lens-side CPU

122, 207: RAM

124, 228: ROM

126, 226: flash ROM

150: lens-side communication section

160: lens mount

200: camera body

201: image sensor

202: image sensor control section

203: analog signal processing section

204: A/D converter

205: image input controller

206: digital signal processing section

208: compression/expansion processing section

208A: compression processing section

210: media control section

212: memory card

214: display control section

216: liquid crystal monitor

220: body-side CPU

222: operation section

224: clock section

230: AF control section

232: AE control section

234: white balance correction section

236: wireless communication section

238: GPS receiving section

240: power control section

242: battery

244: lens power switch

250: body-side communication section

260: body mount

270: flash light emission section

272: flash control section

280: focal plane shutter

296: FPS control section

300: video

302: video acquisition section

310: orthogonal transformer

320: quantization section

330: encoding section

340: bit rate control section

350: image capturing mode selection section

352: compression processing selection section

354: image capturing frame rate acquisition section

356: environment information acquisition section

357: image capturing time reception section

358: capacity detection section

360: video file generation section

370: recording section

380: recording medium

390: communication section

392: first communication interface

394: second communication interface

500: smartphone

501: main control section

502: housing

510: wireless communication section

520: display and input section

521: display panel

522: operation panel

530: call section

531: speaker

532: microphone

540: operation section

541: camera section

550: recording section

551: internal storage section

552: external storage section

560: external input and output section

562: external storage section

570: GPS receiving section

580: motion sensor section

590: power section

S10 to S42: step

What is claimed is:

1. An image processing device comprising:
a processor configured to
acquire a video with a variable image capturing frame rate, as a video acquisition section;
select a first video capturing mode or a second video capturing mode in which an exposure time per frame is set to be shorter than that in the first video capturing mode, as an image capturing mode selection section;
select first compression processing in a case where the first video capturing mode is selected or select second compression processing in a case where the second video capturing mode is selected, as a compression processing selection section; and
compress the video acquired by the video acquisition section and perform the first compression processing or second compression processing selected by the compression processing selection section, as a compression processing section,
wherein in the second compression processing, a change in a capacity of the compressed video per one frame with respect to the change in the image capturing frame rate is set to be small, as compared with in the first compression processing.

2. An image processing device comprising:
a processor configured to
acquire a video with a variable image capturing frame rate, as a video acquisition section;
select first compression processing or second compression processing, as a compression processing selection section;
compress the video acquired by the video acquisition section and perform the first compression processing or second compression processing, selected by the compression processing selection section, as a compression processing section; and
generate a video file of the video compressed by the compression processing section, as a video file generation section,
wherein in the second compression processing, a change in a capacity of the compressed video per one frame with respect to the change in the image capturing frame rate is set to be small, as compared with in the first compression processing,
the compression processing selection section selects the first compression processing or the second compression processing, according to an environment of a device connected to the video file generation section, and
the environment is any one of a transfer speed of a recording medium or a communication interface, which is connected to the video file generation section, or a remaining capacity of the recording medium.

3. The image processing device according to claim 1,
wherein in the second compression processing, a change in a capacity of a compressed video per unit time with respect to a change in the image capturing frame rate is set to be large, as compared with in the first compression processing.

4. The image processing device according to claim 2,
wherein the processor is further configured to record the video file generated by the video file generation section on a first recording medium that does not have a transfer speed required for recording a video file of a video compressed by the second compression processing or a second recording medium having the transfer speed, as a recording section, and
wherein the compression processing selection section selects the first compression processing in a case where the recording section records the video file on the first recording medium or the second compression processing in a case where the recording section records the video file on the second recording medium.

5. The image processing device according to claim 2,
wherein the processor is further configured to transfer the video file generated by the video file generation section to an external device through a first communication interface that does not have a transfer speed required for transferring a video file compressed by the second compression processing or a second communication interface having the transfer speed, as a communication section,
wherein the compression processing selection section selects the first compression processing in a case where the communication section transfers the video file through the first communication interface or the second compression processing in a case where the communication section transfers the video file through the second communication interface.

6. The image processing device according to claim 2,
wherein the processor is further configured to record the video file generated by the video file generation section on the recording medium, as a recording section,
receive an image capturing time of a video, as an image capturing time reception section, and
detect the remaining capacity of the recording medium, as a capacity detection section, and
wherein the compression processing selection section selects the first compression processing in a case where the detected remaining capacity of the recording medium is less than a capacity required for recording a video file compressed by the second compression processing or the second compression processing in a case where the detected remaining capacity of the recording medium is equal to or larger than the capacity required for recording the video file compressed by the second compression processing, during the received image capturing time of the video.

7. The image processing device according to claim 1,
wherein the processor is further configured to generate a video file of a video compressed by the compression processing section, as a video file generation section, and
wherein the video file generation section divides a video compressed by the second compression processing according to the change in the image capturing frame rate to create a plurality of video files, and
creates a video file of a video compressed by the first compression processing regardless of the change in the image capturing frame rate.

8. The image processing device according to claim 7, further comprising:
wherein the processor is further configured to record the video file generated by the video file generation section, as a recording section, and
wherein the recording section records the plurality of video files created from the video compressed by the second compression processing in different storage regions of a recording medium or in different recording media.

9. The image processing device according to claim 1,
wherein the first compression processing and the second compression processing perform compression processing on the video acquired by the video acquisition section according to a set bit rate set in advance for each image capturing frame rate,
in a case where the image capturing frame rate is a first frame rate, the set bit rate of the second compression processing is equal to or higher than the set bit rate of the first compression processing, and
in the second compression processing, an amount of change in the set bit rate in a case where the image capturing frame rate changes from the first frame rate to a second frame rate larger than the first frame rate is larger than that in the first compression processing.

10. The image processing device according to claim 9,
wherein in a case where the first frame rate is α1, the second frame rate is α2, a third frame rate larger than the second frame rate is α3, the set bit rate in the first frame rate is β1, the set bit rate in the second frame rate is β2, and the set bit rate in the third frame rate is β3, the second compression processing satisfies the following expression (1)
(β2−β1)/(α2−α1)>(β3−β2)/(α3−α2) (1).

11. The image processing device according to claim 9,
wherein the compression processing section determines a quantization parameter of image data of frames constituting the video acquired by the video acquisition section to be equal to or less than an upper limit value and compresses the image data using the determined quantization parameter, and
a difference between the second frame rate of the second compression processing and the upper limit value of the first frame rate is smaller than a difference between the second frame rate of the first compression processing and the upper limit value of the first frame rate.

12. The image processing device according to claim 1,
wherein in the second video capturing mode, at least one of a speed of autofocus, a tracking speed of automatic exposure, a tracking speed of white balance, or a frame rate is set to be faster than that in the first video capturing mode.

13. An image capturing device comprising:
a video capturing processor configured to capture a video with a variable image capturing frame rate; and
the image processing device according to claim 1,
wherein the video acquisition section acquires the video captured by the video capturing processor.

14. An image capturing device comprising:
a video capturing processor configured to capture a video with a variable image capturing frame rate; and
the image processing device according to claim 2,
wherein the video acquisition section acquires the video captured by the video capturing processor.

15. An image capturing device comprising:
a video capturing processor configured to capture a video with a variable image capturing frame rate; and
the image processing device according to claim 3,
wherein the video acquisition section acquires the video captured by the video capturing processor.

16. An image capturing device comprising:
a video capturing processor configured to capture a video with a variable image capturing frame rate; and
the image processing device according to claim 4,
wherein the video acquisition section acquires the video captured by the video capturing processor.

17. An image processing method comprising:
acquiring a video with a variable image capturing frame rate;
selecting first compression processing or second compression processing;
compressing the acquired video and performing the selected first compression processing or second compression processing; and
selecting a first video capturing mode or a second video capturing mode in which an exposure time per frame is set to be shorter than that in the first video capturing mode,
wherein in the second compression processing, a change in a capacity of the compressed video per one frame with respect to the change in the image capturing frame rate is set to be small, as compared with in the first compression processing, and
in selecting the first compression processing or the second compression processing, the first compression processing is selected in a case where the first video capturing mode is selected and the second compression processing is selected in a case where the second video capturing mode is selected.

18. An image processing method comprising:
acquiring a video with a variable image capturing frame rate;
selecting first compression processing or second compression processing;
compressing the acquired video and performing the selected first compression processing or second compression processing; and
generating a video file of the compressed video, by a video file generation section,
wherein in the second compression processing, a change in a capacity of the compressed video per one frame with respect to the change in the image capturing frame rate is set to be small, as compared with in the first compression processing,
in selecting the first compression processing or the second compression processing, the first compression processing or the second compression processing is selected according to an environment of a device connected to the video file generation section, and
the environment is any one of a transfer speed of a recording medium or a communication interface, which is connected to the video file generation section, or a remaining capacity of the recording medium.

19. The image processing method according to claim 17,
wherein in the second compression processing, a change in a capacity of a compressed video per unit time with respect to a change in the image capturing frame rate is set to be large, as compared with in the first compression processing.

20. The image processing method according to claim 17,
wherein the first compression processing and the second compression processing perform compression processing on the acquired video according to a set bit rate set in advance for each image capturing frame rate,
in a case where the image capturing frame rate is a first frame rate, the set bit rate of the second compression processing is equal to or higher than the set bit rate of the first compression processing, and
in the second compression processing, an amount of change in the set bit rate in a case where the image capturing frame rate changes from the first frame rate to a second frame rate larger than the first frame rate is larger than that in the first compression processing.
